(19) United States
(12) Patent Application Publication
(10) Pub. No.: US 2013/0166570 A1
(43) Pub. Date: Jun. 27, 2013

(54) COMPUTER SYSTEM MANAGEMENT METHOD AND MANAGEMENT APPARATUS

(71) Applicants: Yusuke Takada, Yokohama (JP); Yoichiro Tsuge, Yokohama (JP); Tetsuya Maita, Yokohama (JP); Toshiyuki Haruma, Yokohama (JP)

(72) Inventors: Yusuke Takada, Yokohama (JP); Yoichiro Tsuge, Yokohama (JP); Tetsuya Maita, Yokohama (JP); Toshiyuki Haruma, Yokohama (JP)

(73) Assignee: HITACHI, LTD., Tokyo (JP)

(21) Appl. No.: 13/321,109

(22) PCT Filed: Sep. 8, 2010
(86) PCT No.: PCT/JP10/65418

§ 371 Date: Nov. 17, 2011

(51) Int. Cl. G06F 17/30

(52) U.S. Cl. CPC G06F 17/30424
USPC 707/748; 707/758

(57) ABSTRACT

An object of the present invention is to appropriately select a volume or the like to be allocated to a host computer, thereby decreasing work efficiency. Upon being inputted with a precondition (for example, a user ID, a host ID and a work label ID) based on information inputted from a user, a management server 10 identifies a search condition set corresponding to the precondition and recommends this search condition set to the user. The user can utilize the recommended search condition as-is, or after changing a portion thereof. The management server instructs a storage system to allocate the retrieved volume or the like to the host.

### TECHNICAL FIELD

The present invention relates to a computer system management method and a management apparatus.

### BACKGROUND ART

The amount of data managed at companies and the like is increasing on a daily basis. The system administrator and other such users allocate to a host computer a logical volume of the size required by this host computer. However, the configuration of a computer system is complex, and it takes time to find a logical volume that is suitable for the host computer and to allocate this volume to the host computer, resulting in poor usability.

Accordingly, technology has been proposed in which the request characteristics for each application program and an anticipated disk performance are defined beforehand as a policy, and a logical volume that matches a policy that has been selected by the user from among the defined policies is decided on as the logical volume to be allocated to the host computer (Patent Literature 1).

### CITATION LIST

### Patent Literature

[PTL 1]

Japanese Patent Laid-open Publication No. 2004-334561

### SUMMARY OF INVENTION

### Technical Problem

The prior art disclosed in the above-mentioned patent literature facilitates the reusing of a search condition that was utilized in the past by storing a search condition as a policy. This prior art strives to lessen the input work of the user.

However, in the prior art, because it is necessary to define and store policies in proportion to the number of combinations of search conditions, the longer the system is operated, the larger the number of policies that get created. Therefore, the task of managing the large number of policies must be carried out, thereby increasing the burden on the user. In addition, the larger the number of policies, the more difficult it is to select an appropriate policy from among the group of policies, lowering user usability.

Accordingly, an object of the present invention is to provide a computer system management method and a management apparatus that make it possible to enhance user usability. Another object of the present invention is to provide a computer system management method and a management apparatus that make it possible to enhance user usability by recommending to the user information for use in searching for a storage area based on the user operation history. Further objects of the present invention should become clear from the description of the embodiment explained further below.

### Solution to Problem

One aspect for solving the above-mentioned problem is a method for managing a computer system, which comprises one or more host computers, one or more storage systems for storing data to be used by the host computers, and a management apparatus, wherein the management apparatus (A) receives at least a required storage size and host identification information for identifying the host computer as a precondition for searching for one or more storage areas to be allocated to the host computer from among multiple storage areas of the storage system, (B) receives further one or more search conditions for searching for one or more storage areas to be allocated to the host computer from among the multiple storage areas, (C) detects, based on the precondition and the search conditions, one or more storage areas from among the multiple storage areas of the storage system as candidates, (D) presents the detected candidates to a user, (E) receives storage area identification information for identifying a storage area selected by the user from among the presented candidates, (F) instructs the storage system to allocate, to the host computer, the storage area identified by the storage area identification information, by specifying the storage area identification information and notifying the storage system, (G) updates, based on the search conditions, priority management information for managing priorities related to the search conditions, (H) upon receiving the precondition once again, creates, based on the priorities managed in the priority management information, one or more search condition sets comprising one or more search conditions as recommended search condition sets to be recommended to the user, (I) detects, based on the search conditions included in the recommended search condition set, one or more storage areas from among the respective storage areas of the storage system as candidates, and (J) associates the detected candidates and the search conditions included in the recommended search condition set and presents same for each of the recommended search condition sets.

In addition, the management apparatus may (K) update priorities managed by the priority management information based on the recommended search condition set selected by the user from among the recommended search condition sets that have been presented.

The present invention can also be comprised as a computer system that is executed by the management apparatus for managing the computer system. This computer program can be distributed affixed to a recording medium or delivered via a communication network.

### BRIEF DESCRIPTION OF DRAWINGS

FIG. 1 is a schematic diagram showing an overview of an embodiment of the present invention.

FIG. 2 shows an overview of the entire computer system.

FIG. 3 is a block diagram showing the configuration of a management server.

FIG. 4 is a block diagram showing the configuration of a storage system.

FIG. 5 is a table showing an example of storage system configuration information.

FIG. 6 is a table showing the corresponding relationship between the storage system and a logical volume.

FIG. 7 is a table showing the corresponding relationship between a communication port and a host group.

FIG. 8 is a table showing the corresponding relationship between the logical volume and the communication port.

FIG. 9 is a diagram schematically showing the configuration and relationship of a recommendation information management area.

FIG. 10 is a table for managing users.

FIG. 11 is a table for managing labels showing types of business application programs.

FIG. 12 is a table for managing host computers.

FIG. 13 is a condition type detection table showing the relationship between a combination of preconditions for a search and a condition type identifier.

FIG. 14 is a table for managing condition types.

FIG. 15 is a table for managing a priority for each search condition.

FIG. 16 is a flowchart showing the processing for registering user information and access control information.

FIG. 17 is an example of a screen for registering the user information.

FIG. 18 is an example of a screen for registering the access control information.

FIG. 19 is a flowchart showing the processing for providing recommendation information.

FIG. 20 is an example of a screen for registering host information.

FIG. 21 is an example of a screen for inputting information (a precondition) for allocating a volume to the host.

FIG. 22 is an example of a screen for providing the recommendation information.

FIG. 23 is a flowchart showing the processing for detecting the recommendation information.

FIG. 24 is a flowchart showing the processing for acquiring a priority.

FIG. 25 is a flowchart showing the processing for updating a recommendation information management area.

FIG. 26 is a flowchart showing the processing for calculating a priority.

### DESCRIPTION OF EMBODIMENTS

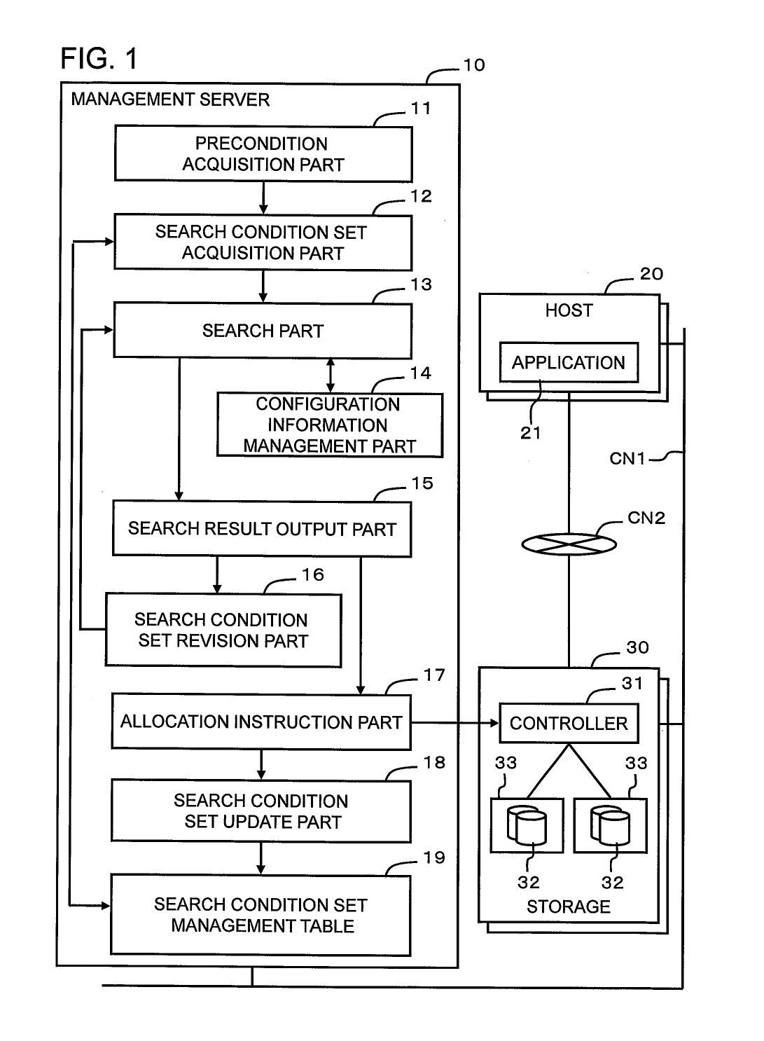

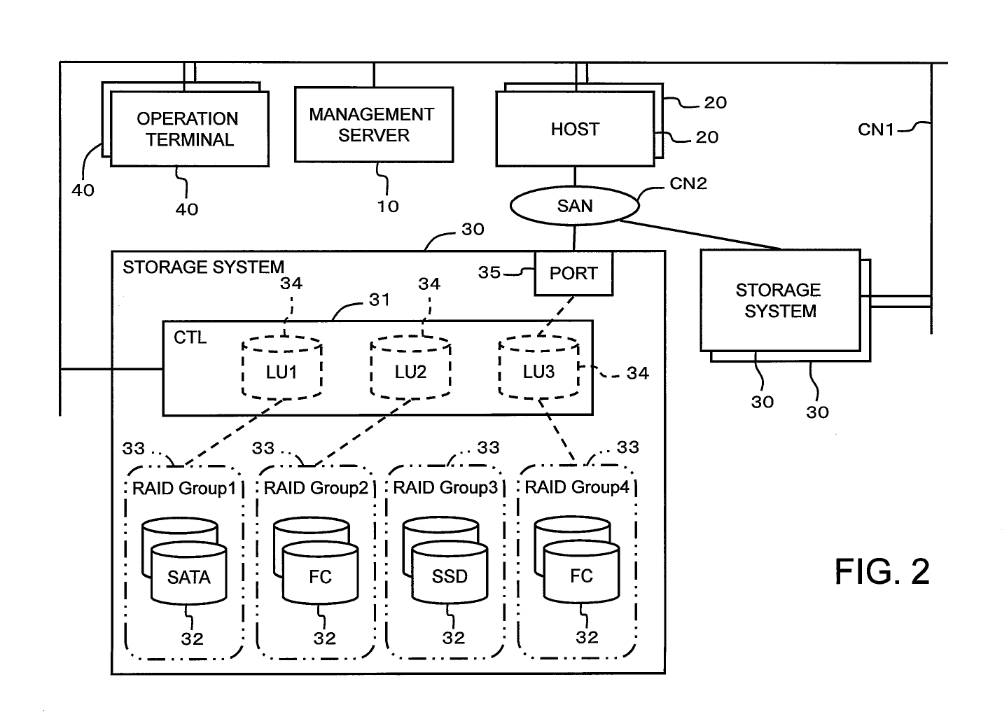

The aspects of the embodiment of the present invention will be explained hereinbelow based on the drawings. First of all, an overview of the present invention will be explained by referring to FIG. 1, and next examples will explained by referring to FIG. 2 and subsequent figures. FIG. 1 is described to the extent necessary to understand and implement the present invention. The scope of the present invention is not limited to the configuration described in FIG. 1. Characteristic features not described in FIG. 1 will be made clear in the examples that will be explained further below.

As shown in FIG. 1, the computer system comprises at least one management server 10, at least one host computer 20, and at least one storage system 30. The management server 10 is coupled to the host computer 20 and the storage system 30 via a management communication network CN1. The host computer 20 and the storage system 30 are coupled via an I/O (Input/Output) network CN2 for sending and receiving data.

First, the host computer 20 and the storage system 30 will be explained, and next the management server 10 will be explained. The host computer 20, for example, is configured as a computer, either a so-called open server computer or a mainframe computer. In a case where the host computer 20 is a mainframe computer, for example, data communications are carried out in accordance with a communication protocol such as FICON (Fibre Connection: registered trademark), ESCON (Enterprise System Connection: registered trademark), ACONARC (Advanced Connection Architecture: registered trademark), or FIBARC (Fibre Connection Architecture: registered trademark). In a case where the host computer 20 is a server computer, for example, data communications are carried out in accordance with a communication protocol such as FCP (Fibre Channel Protocol) or iSCSI (internet Small Computer System Interface).

The host computer 20, for example, comprises at least one application program 21, such as customer management software, product management software, sales management software, electronic mail management software, wordprocessing software, spreadsheet software, image processing software, and image delivery software. The application program 21 accesses an allocated logical volume to read and write data. The storage system 30 comprises a controller 31, multiple storage apparatuses 32, and a RAID group 33. The controller 31 reads/writes data from/to a logical volume 34 (refer to FIG. 2) in accordance with a command from the host computer 20. In addition, the controller 31 changes the configuration of the storage system 30 in accordance with an instruction from the management server 10.

The storage apparatus 32 is for storing data. For example, various types of devices that are capable of reading and writing data, such as a hard disk device, a semiconductor memory device, an optical disk device, a magneto-optical disk device, a magnetic tape device, and a flexible disk device can be used as a storage apparatus 32.

In a case where a hard disk device is used as the storage apparatus, for example, FC (Fibre Channel) disks, SCSI (Small Computer System Interface) disks, SATA disks, ATA (AT Attachment) disks, and SAS (Serial Attached SCSI) disks can be used. Furthermore, for example, various types of storage apparatuses, such as a flash memory (SSD), a FeRAM (Ferroelectric Random Access Memory), a MRAM (Magnetoresistive Random Access Memory), an Ovonic Unified Memory, and a RRAM (Resistance RAM) may also be used. In addition, for example, the configuration may also be such that different types of storage apparatuses are intermixed, such as a flash memory device and a hard disk drive.

The RAID group 33, for example, denotes a group for each RAID level, i.e., RAID 1, 5 and 6. The RAID group 33 comprises at least one storage apparatus 32.

As will be explained further below, the management server 10, which serves as the “management apparatus”, upon receiving a precondition for a search from the user, creates a recommended search condition set comprising a search condition corresponding to this precondition, and presents a logical volume or RAID group that matches this recommended search condition set to the user as a candidate. The management server 10 issues an instruction to the storage system 30 based on the user selection, and also updates a priority associated with the search condition based on the user's selection. Furthermore, a communication path may be presented to the user as a candidate.

An example of the configuration of the management server 10 will be explained. The management server 10, for example, comprises a precondition acquisition part 11, a search condition set acquisition part 12, a search part 13, a configuration information management part 14, a search result output part 15, a search condition set revision part 16, an allocation instruction part 17, a search condition set update part 18, and a search condition set management table 19.

The precondition acquisition part 11 acquires a condition, which constitutes the premises of a search, from the user. For example, information for identifying a user (a username), information for identifying the type of application program 21 running on the host computer 20 (a work label name), and information for identifying a host computer 20 (a hostname) can be cited as preconditions.

The search condition set acquisition part 12 acquires from the search condition set management table 19 a search condition set that corresponds to the precondition. The search condition set comprises at least one search condition. The search condition set is a set of search conditions recommended to the user, and is equivalent to the “recommended search condition set”.

The search condition comprises a condition type and a condition value. For example, a storage system model name, a disk type, rotations per minute (RPM), a RAID level, a volume type, and a path can be cited as condition types. The condition value will differ for each condition type.

For example, in a case where the condition type is “storage system model name”, a value like model 1, model 2 and so forth is configured as the condition value. In a case where the condition type is “disk type”, a value such as FC, SCSI, SATA, ATA, SAS, or SSD (Flash Solid State Drive) is configured as the condition value. In a case where the condition type is “RPM”, a value like 10000 or 15000 is configured as the condition value. In a case where the condition type is “RAID level”, a value like RAID 1, RAID 5, or RAID 6 is configured as the condition value. In addition, it is also possible to configure a condition expression like “=”, “≠”, “includes”, and “excludes” in the condition value. For example, “=FC” specifies a FC disk. “≠FC” specifies another type of disk besides FC. “Includes FC” specifies other types of disks that include FC disks.

The search part 13, based on the search condition set, searches configuration information that is managed by the configuration information management part 14. The management information is information denoting the configuration of the storage system 30. The search part 13 selects at least one logical volume or RAID group 33 candidate to be allocated to the host computer 20.

The “storage apparatus” allocated to the host computer 20 is not limited to a logical volume or a RAID group 33. For example, the configuration may also be such that a unit such as a pool is allocated to the host computer 20. This pool is used in what is referred to as Thin Provisioning technology. In Thin Provisioning technology, a virtual volume of an ostensible size is provided to the host computer 20, and a real storage area to be allocated to the virtual volume is added in accordance with a write access from the host computer 20. The real storage area that is allocated to the virtual volume is selected from among the logical volumes inside a pool. A logical volume or RAID group 33 (or a pool) that serves as a storage area to be allocated to the host computer 20 may be called the “volume or the like”.

The result of a search by the search part 13 is outputted via the search result output part 15. The search result output part 15, for example, displays the search result on a screen of an operation terminal 40 (refer to FIG. 2) that is coupled to the management server 10.

The search result, for example, comprises a display part for each search condition set. Each display part comprises information related to the search condition comprising the search condition set, and information denoting the result of the search that utilized this search condition set. The information related to the search condition comprises the condition type and the condition value. At least a part of the information related to the search condition is provided in a user-revisable form. The information denoting the search result comprises information for identifying a volume or the like to be allocated to the host computer 20.

In a case where the user wishes to revise either all or part of the recommended search condition set, either all or a part of the search condition set is revised by the search condition set revision part 16, and the search is carried out once again by the search part 13.

The user compares the display part for each search condition set, decides on a volume or the like to be allocated to the host computer 20, and instructs the management server 10 to execute an allocation. The allocation instruction part 17, which receives the user instruction, sends to the controller 31 of the storage system 30 an instruction to allocate to the host computer 20 specified by the user the volume or the like that has been selected by the user. The controller 31 changes the configuration of the storage system 30 such that the specified host computer 20 is able to use the specified volume or the like in accordance with the instruction from the allocation instruction part 17.

The search condition set update part 18, upon the allocation instruction to the storage system 30 having ended normally, updates the contents of the search condition set management table 19. The search condition set management table 19 is stored such that the precondition inputted from the user is associated with a search condition set used in the past. A priority, which denotes the utilization frequency, is respectively configured in each search condition that comprises the search condition set used in the past. A higher priority signifies that the utilization frequency of this search condition set is high.

The search condition set update part 18 configures a priority that is associated with the search condition selected by the user from among the respective search conditions stored in the search condition set management table 19 as high. Alternatively, the search condition set update part 18 configures a low priority for a search condition that has not been selected by the user from among the respective search conditions stored in the search condition set management table 19.

Furthermore, the search condition set update part 18, in a case where the user-selected search condition has not been registered in the search condition set management table 19, adds this search condition to the search condition set management table 19.

In this embodiment, which is configured like this, the user simply inputs a precondition for carrying out a search into the management server 10, and at least one search condition set corresponding to this precondition is recommended to the user from the management server 10. The user is able to use the recommended search condition set as-is, or to revise apart of the recommended search condition set prior to use. Therefore, the user does not have to specify all the search condition sets, but rather is able to select an appropriate volume or the like by simply inputting a precondition. This enhances user convenience.

In this embodiment, the longer a user utilizes the computer system, the more of this user's search histories are stored in the search condition set management table 19. Therefore, it is possible to enhance the accuracy of the search condition set and candidate, i.e., the search result, recommended to the user.

In the examples described below, the scope of the search condition set selections recommended to the user are broadened for a user who is using the computer for the first time or a user who uses the computer system for a short period of time.

### EXAMPLE 1

FIG. 2 shows the entire computer system related to this example. As described using FIG. 1, at least one management server 10 is coupled to at least one host computer 20, at least one storage system 30, and at least one operation terminal 40 via a management communication network CN1 like a LAN (Local Area Network). The host computer 20 and the storage system 30 are coupled via an I/O communication network CN2 like a SAN (Storage Area Network). Hereinbelow, each of the host computer 20, the storage system 30, and the operation terminal 40 will be described as existing in multiples.

The management server 10, as shown in FIG. 2, comprises a controller 31, a storage apparatus 32, a RAID group 33, a logical volume 34, and a communication port (hereinafter, called the port) 35.

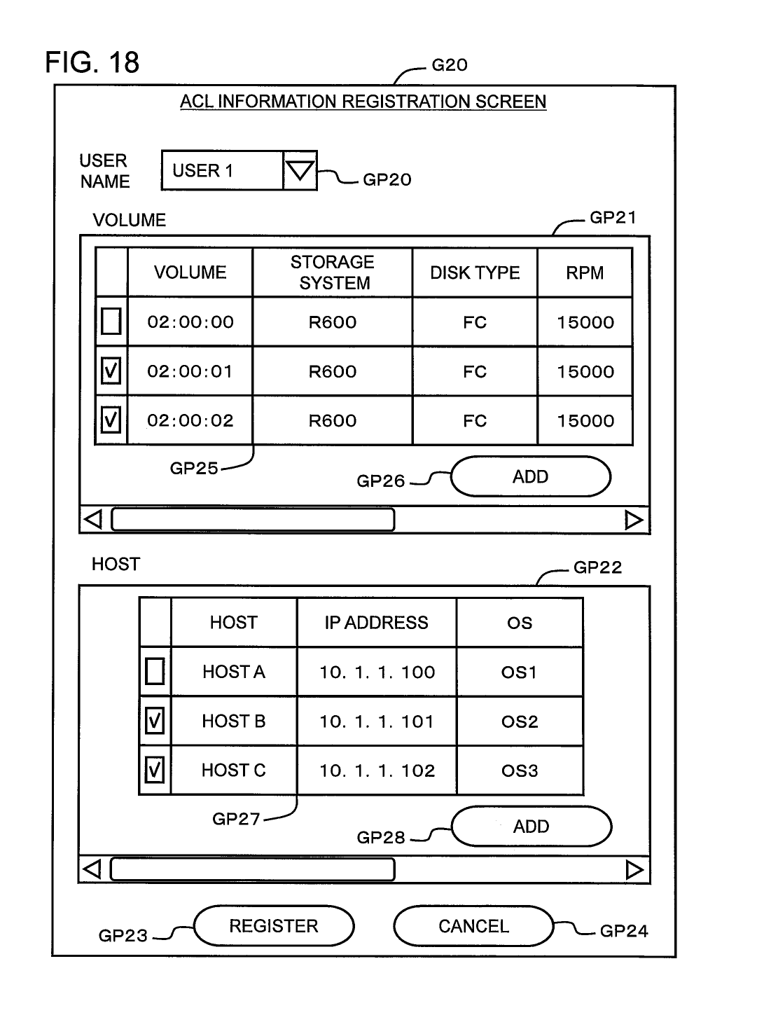

The logical volume 34 is created using a physical storage area that has been virtualized as a RAID group 33. Multiple logical volumes 34 can be disposed in a single RAID group 33. The logical volume 34 is associated with a prescribed host computer 20 via the communication port 35. In other words, each host computer 20 is only able to access the logical volume 34 that has been allocated to itself, and is not able to access a logical volume 34 that has not been allocated to itself. As shown in FIG. 18, which will be described further below, information that lists up host computers and logical volumes that the user is able to access from among the logical volume 34-related information and host computer 20-related information managed by the management server 10 is called the access control list (ACL).

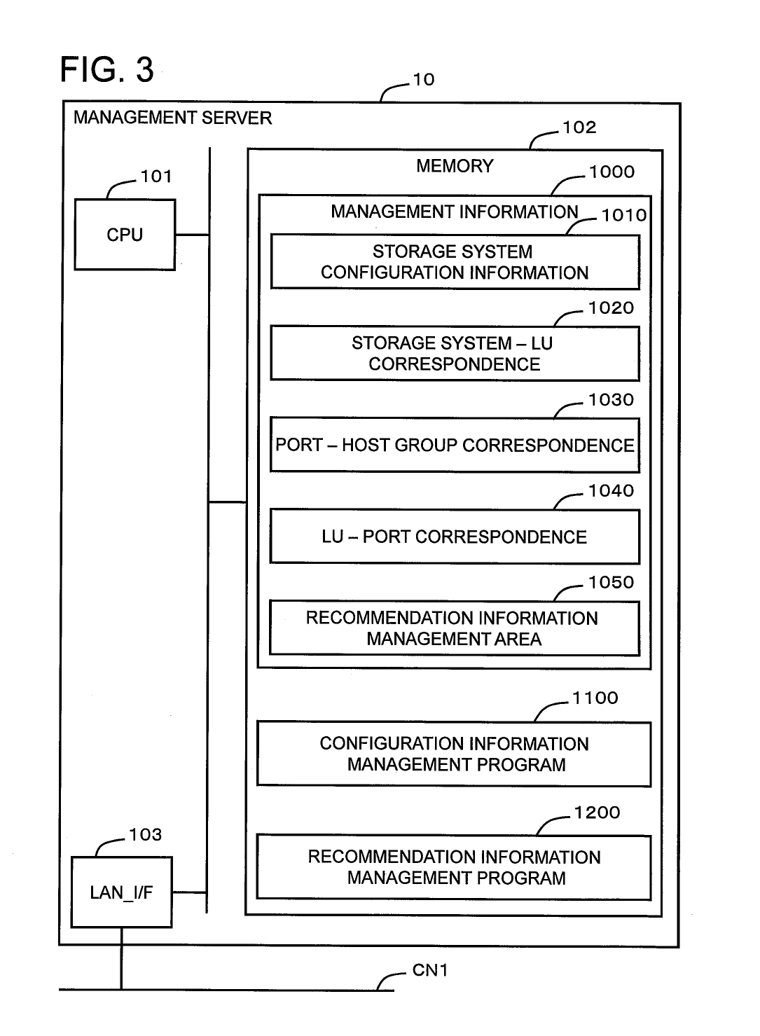

FIG. 3 is a block diagram of the management server 10. The management server 10 can comprise multiple computers, and, as shown in FIG. 3, can also be configured as a single computer.

The management server 10, for example, comprises a microprocessor (CPU) 101, a memory 102, and a communication interface (LAN_I/F) 103.

The microprocessor 101 realizes the functions described hereinbelow by reading and executing a computer program that is stored in the memory 102. The memory 102 stores various types of management information 1000, a configuration information management program 1100, and a recommendation information management program 1200. Furthermore, for convenience sake, one memory 102 is shown in FIG. 3, but the management server 10 may also comprise multiple memories.

The memory 102, in addition to semiconductor memories, such as RAM (Random Access Memory) and ROM (Read Only Memory), for example, can also comprises an auxiliary storage apparatus like a hard disk device or a flash memory device.

The management server 10 is coupled to each operation terminal 40 via the management communication network CN1. Each operation terminal 40, for example, is a computer terminal comprising a microprocessor, a memory, a communication interface, an information input apparatus such as a keyboard, and an information output apparatus such as a display. The user can use an operation terminal 40 to which the user has utilization privileges to instruct the management server 10 to allocate a volume.

In FIG. 3, an example is given of a case in which the operation terminal 40 for exchanging information with the user, and the management server 10 for carrying out a search for a volume or the like and allocating a volume or the like are configured as separate computers. But the present invention is not limited to this, and the configuration may be such that a user interface is disposed in the management server 10 to exchange information with the user.

The user, for example, can use a keyboard switch, a pointing device, a touch panel, a voice input apparatus or the like to input information (information that also includes instructions) to the management server 10. The user, for example, can use a display, a printer, a voice output apparatus or the like to confirm information from the management server 10.

The management information 1000 stored in the memory 102, for example, comprises storage system configuration information 1010, information denoting the corresponding relationship between the storage system and the logical volume (LU) 1020, information denoting the corresponding relationship between the port and a host group 1030, information denoting the corresponding relationship between the logical volume and the port 1040, and a recommendation information management area 1050. Each type of information will be explained in detail further below.

The configuration information management program 1100 is a computer program for managing the respective management information (which is also configuration information) 1010, 1020, 1030, 1040.

The recommendation information management program 1200 is a computer program for managing information stored in the recommendation information management area 1050, supporting a user search, and recommending an appropriate volume.

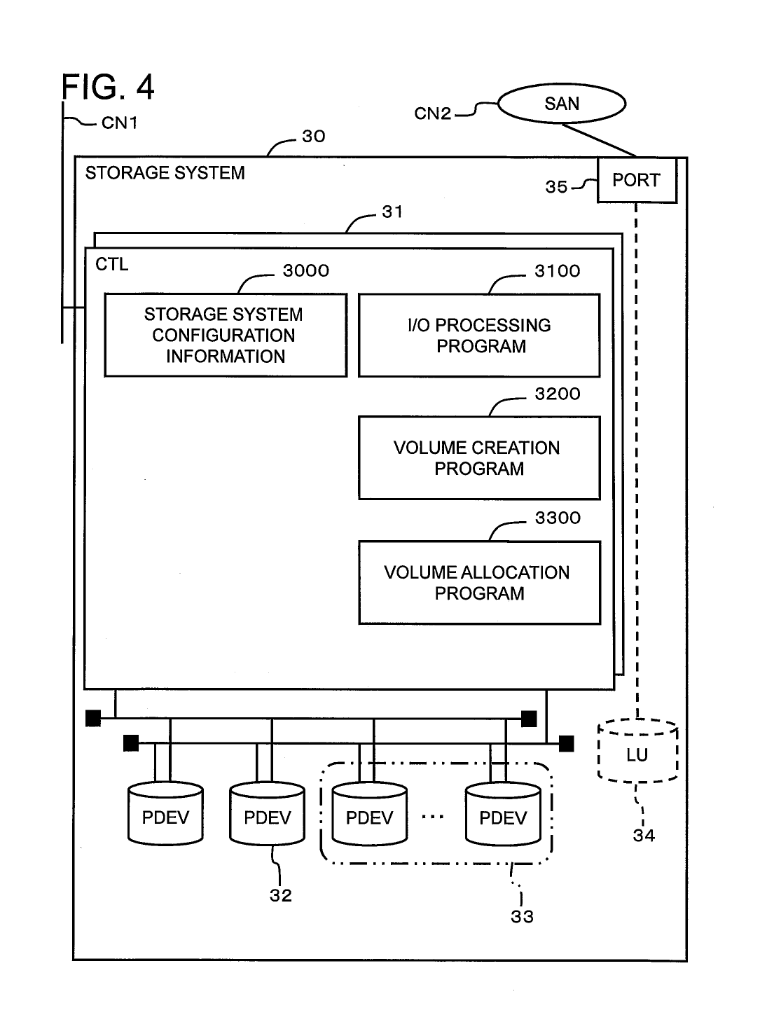

FIG. 4 is a block diagram of the storage system 30. The storage system 30, for example, comprises at least one controller 31 and at least one storage apparatus 32. The controller 31 controls the operation of the storage system 30. As described hereinabove, the RAID group 33 is configured by grouping together multiple storage apparatuses 32. A logical volume 34 is formed by using the physical storage area of the RAID group 33.

The controller 31, for example, comprises a first communication control circuit for communicating with the host computer 20, a second communication control circuit for communicating with the respective storage apparatuses 32, a memory for storing data and control information, and a microprocessor (none of which are shown in the drawing). Providing multiple controller 31 to form a redundant configuration makes it possible for the other controller 31 to control the operation of the storage system 30 in a case where either one of the controllers has failed.

The controller 31, for example, maintains storage system configuration information 3000, an I/O processing program 3100, a volume creation program 3200, and a volume allocation program 3300.

The storage system configuration information 3000 is for managing the configuration of the storage system 30. The I/O processing program 3100 is a computer program, which processes a read command and a write command issued from the host computer 20, and returns the result of this processing to the host computer 20.

The volume creation program 3200 is a computer program for creating a logical volume 34 in accordance with an instruction from the management server 10.

The volume allocation program 3300 is a computer program for allocating a specified logical volume 34 to a specified host computer 20 in accordance with an instruction from the management server 10.

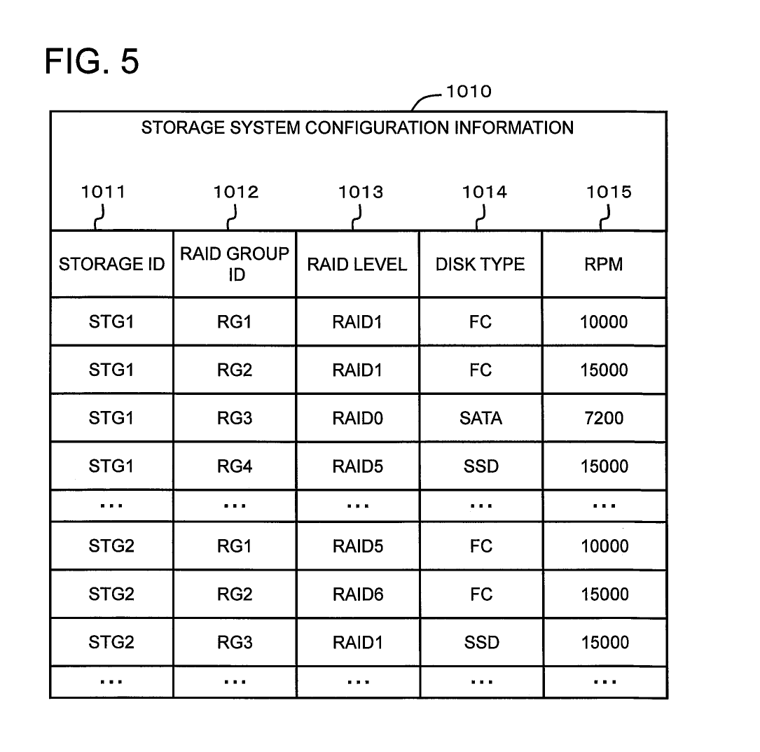

FIG. 5 shows an example of the storage system configuration information 1010. The management server 10, either regularly or irregularly, acquires and stores configuration information from each storage system 30 inside the computer system. Furthermore, in the following explanation, ID, identification information, identifier, and name are interchangeable.

The storage system configuration information 1010, for example, correspondingly manages a storage ID column 1011, a RAID group ID column 1012, a RAID level 1013, a disk type column 1014, and a RPM column 1015.

Information (an ID) for identifying the storage system 30 is stored in the storage ID column 1011. Information (an ID) for identifying the RAID group 33 that is disposed inside each storage system is stored in the RAID group ID column 1012. The RAID level of the RAID group 33 is stored in the RAID level column 1013. The type of the storage apparatuses 32 comprising the RAID group 33 is stored in the disk type column 1014. The rotational speed, that is, the data access speed of the storage apparatus 32 is stored in the RPM (Rotation Per Minute) column 1015.

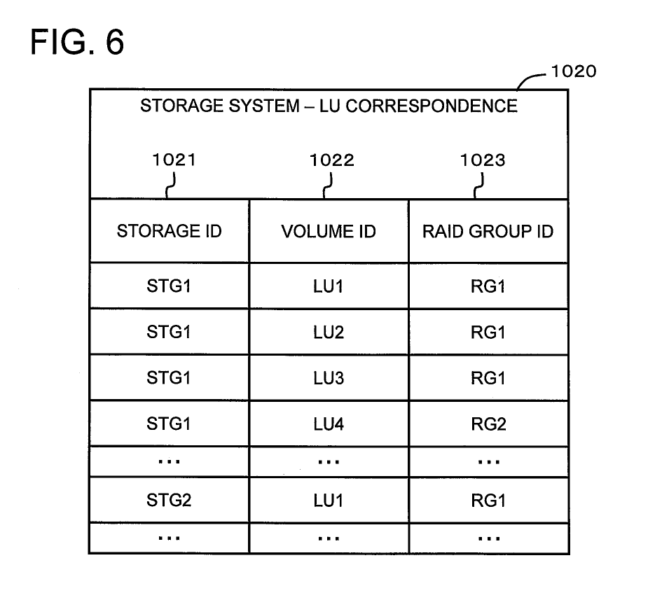

FIG. 6 is an example of information 1020 denoting the corresponding relationship between a storage system and a logical volume. The storage system—logical volume correspondence information 1020, for example, correspondingly manages a storage ID column 1021, a volume ID column 1022, and a RAID group ID column 1023. Information (an ID) for identifying each logical volume 34 is stored in the volume ID column 1022. The management server 10 can use the information 1020 to discern which logical volume is disposed in which storage system.

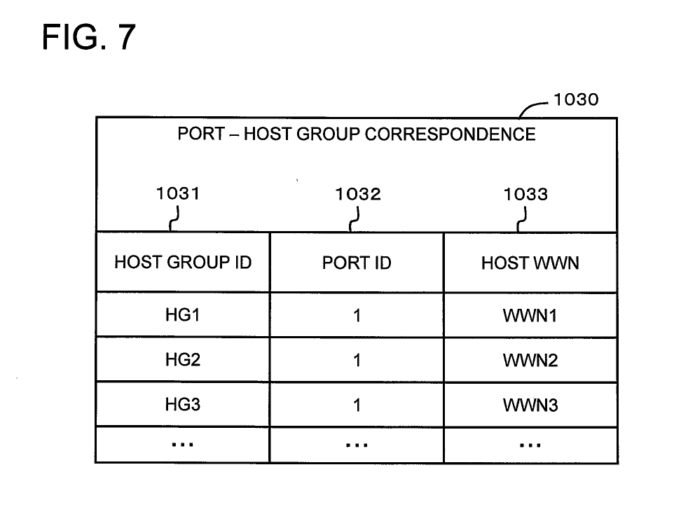

FIG. 7 is an example of information 1030 denoting the corresponding relationship between a port and a host group. The port-host group correspondence information 1030, for example, correspondingly manages a host group ID column 1031, a port ID column 1032, and a host WWN column 1033.

Information (an ID) for identifying a host group is stored in the host group ID column 1031. Associating multiple host computers 20 to a single host group makes it possible to manage multiple host computers 20 as a group. Information (an ID) for identifying each port 35 is stored in the port ID column 1032. The WWN (World Wide Name) of the host computer 20 associated with the port 35 is stored in the host WWN column 1033. The management server 10 can use the information 1030 to discern which host computer 20 is associated with which communication port 35.

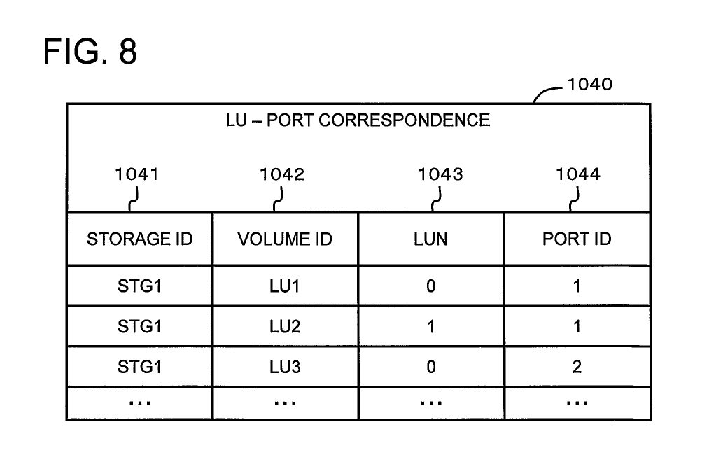

FIG. 8 is an example of information 1040 denoting the corresponding relationship between a logical volume and a port. The logical volume-port correspondence information 1040, for example, correspondingly manages a storage ID column 1041, a volume ID column 1042, a LUN column 1043, and a port ID column 1044. A LUN (Logical Unit Number) is stored in the LUN column 1043. The management server 10 can use the information 1040 to discern which logical volume 34 is associated with the respective ports 35 of the respective storage systems 30.

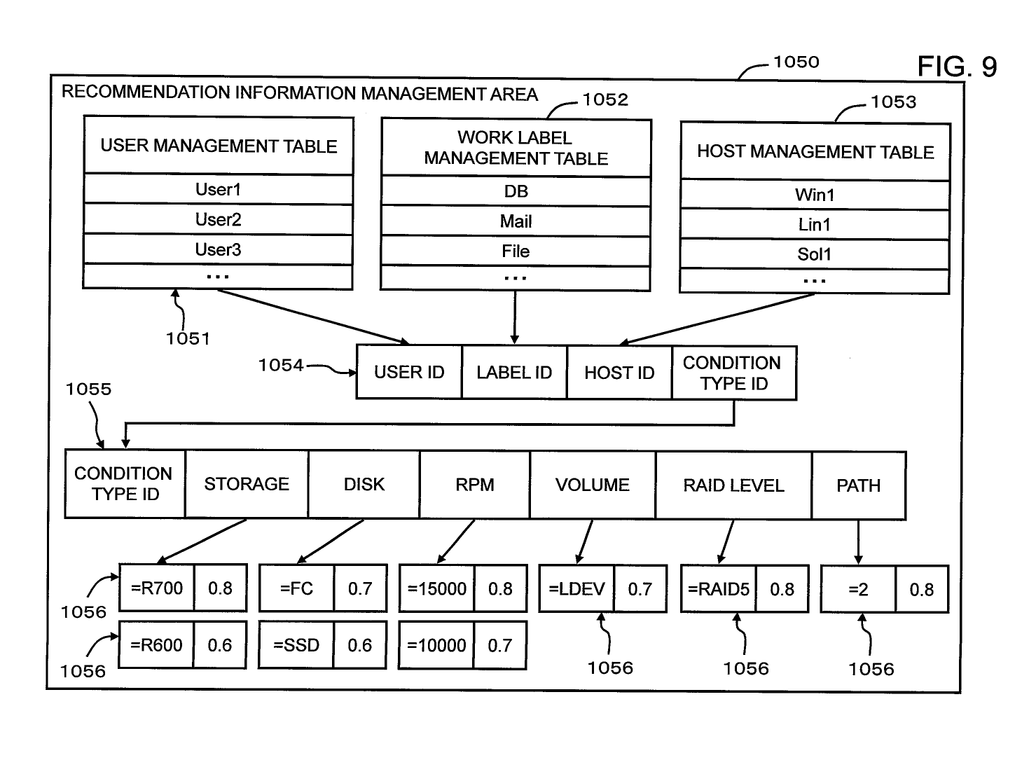

FIG. 9 schematically shows the configuration and so forth of the recommendation information management area 1050. FIG. 9 shows how a search condition set is acquired based on a precondition inputted by the user.

In a case where the user is trying to allocate a volume or the like to the host computer 20, the user inputs a precondition into the management server 10 via the operation terminal 40. In this example, a username (user ID), a work label name (a work label ID), and a hostname (a host ID) are used as this precondition. That is, when the user is going to allocate a logical volume or the like to the host computer 20, he simply specifies the username, the type of application program 21, and the host computer name for which the allocation is intended. Furthermore, “work label” may be abbreviated as “label” in the drawing.

A condition type ID of a condition type detection table 1054 is associated with each combination of items (username, work label name, hostname) comprising the precondition. Therefore, when the user inputs the precondition, a condition type ID corresponding to this precondition is decided.

Based on the decided condition type ID, it is possible to use a condition type management table 1055 to acquire at least one search condition set that corresponds to this condition type ID. The condition type management table 1055 manages multiple search condition combinations for each condition type ID.

In the condition type management table 1055, a priority management table 1056 is associated with each search condition. The priority management table 1056 manages a value (a condition value) configured in the search condition and the priority of this condition value. For example, there may be a case where two sets of condition values and priorities are associated, i.e., condition value “=FC” and priority “0.7”, and condition value “=SSD” and priority “0.6” may be associated with search condition “disk type”. In a case where multiple condition values are associated with a single search condition, the condition value having the highest priority can be selected.

Furthermore, the search condition set management table 19 shown in FIG. 1 corresponds to at least one piece of information stored in the recommendation information management area 1050. For example, the search condition set management table 19 can conceivably correspond to the recommendation information management table 1054, the condition type management table 1055, and the priority management table 1056.

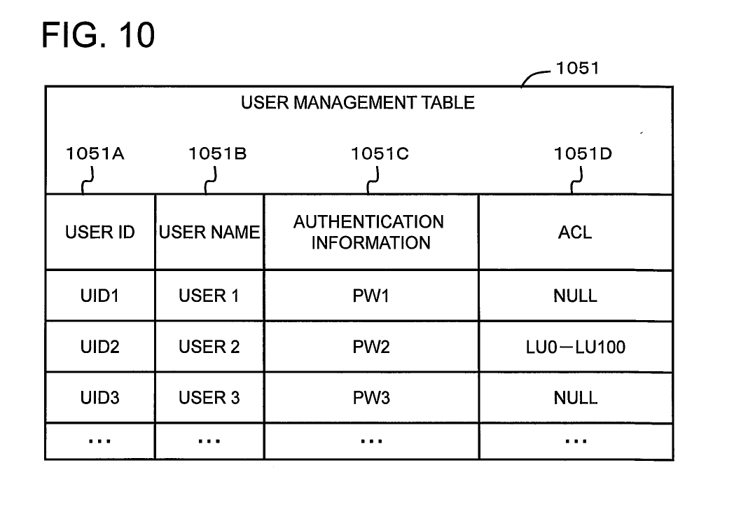

FIG. 10 shows a table 1051 for managing the users. The user management table 1051, for example, correspondingly manages a user ID column 1051A, a username column 1051B, an authentication information column 1051C, and a ACL column 1051D.

Information (an ID) for identifying each user is stored in the user ID column 1051A. The name of each user is stored in the username column 1051B. A password and other such authentication information, which the user uses to log in to the management server 10 via the operation terminal 40, is stored in the authentication information column 1051C. Biometric data may be used either instead of or in addition to a password.

Information related to a volume that a user is able to utilize is stored in the ACL column 1051D. A case where “NULL” is configured in the ACL column signifies that access restrictions have not been configured. A case where a logical volume and a host ID are configured in the ACL column signifies that the user can only access the configured logical volume and host computer.

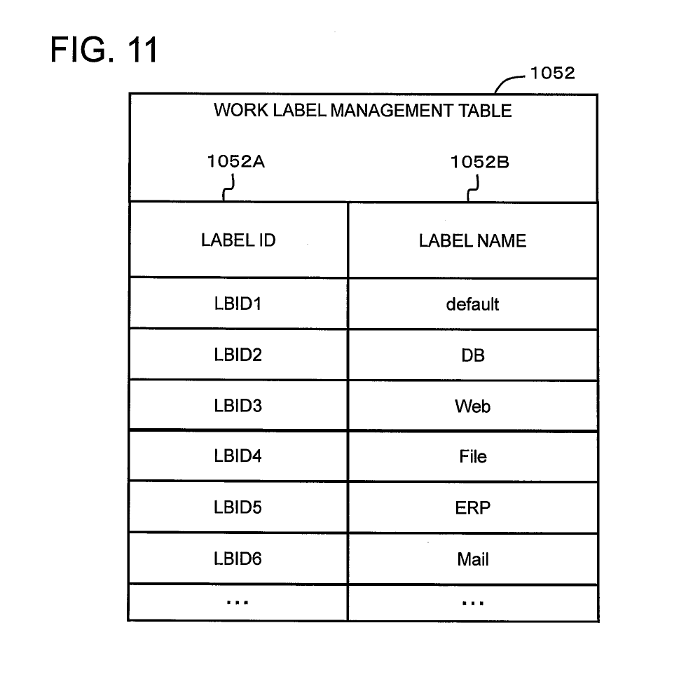

FIG. 11 shows a table 1052 for managing a work label. The work label management table 1052 correspondingly manages a label ID column 1052A and a label name column 1052B. The work label is information denoting the type of an application program 21. Therefore, the “work label” may also be called a “work type”.

Information (an ID) for identifying a label that denotes the type of each application program 21 is stored in the label ID column 1052A. A work label name (a name denoting the application program 21 type) is stored in the label name column 1052B. For example, a value such as “database”, “web”, “file”, “ERP”, “e-mail”, or “initial value” is configured in the work label name.

ERP (Enterprise Resource Planning package) is a software package for integratively managing core businesses. An initial value is configured in a case where the application program 21 type is unclear.

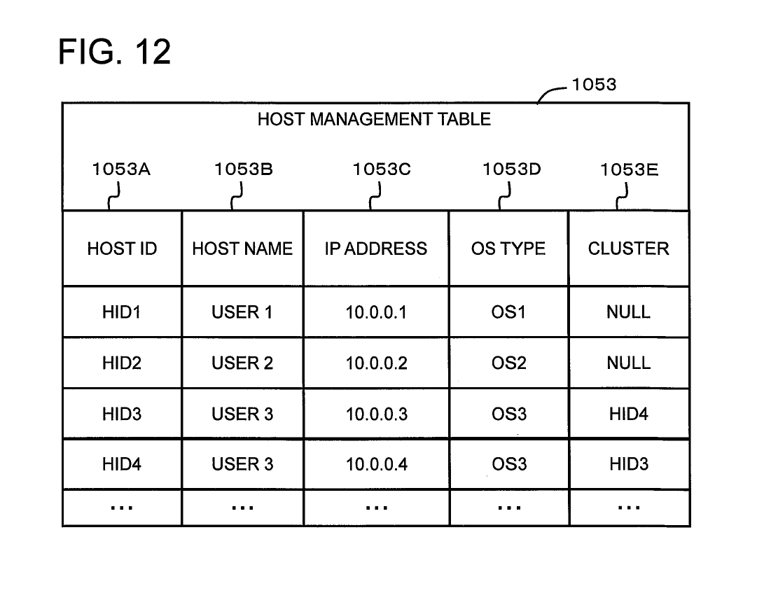

FIG. 12 shows a table 1053 for managing the host computers 20. The host management table 1053, for example, correspondingly manages a host ID column 1053A, a hostname column 1053B, an IP address column 1053C, an operating system type column 1053D, and a cluster column 1053E.

Information (an ID) for identifying each host computer 20 is stored in the host ID column 1053A. The name of a host computer 20 is stored in the hostname column 1053B. The IP (Internet Protocol) address of a host computer 20 is stored in the IP address column 1053C. The type of the operating system running on the host computer 20 is stored in the operating system type column 1053D. In a case where a host computer belongs to a cluster, information for identifying this cluster is stored in the cluster column 1053E.

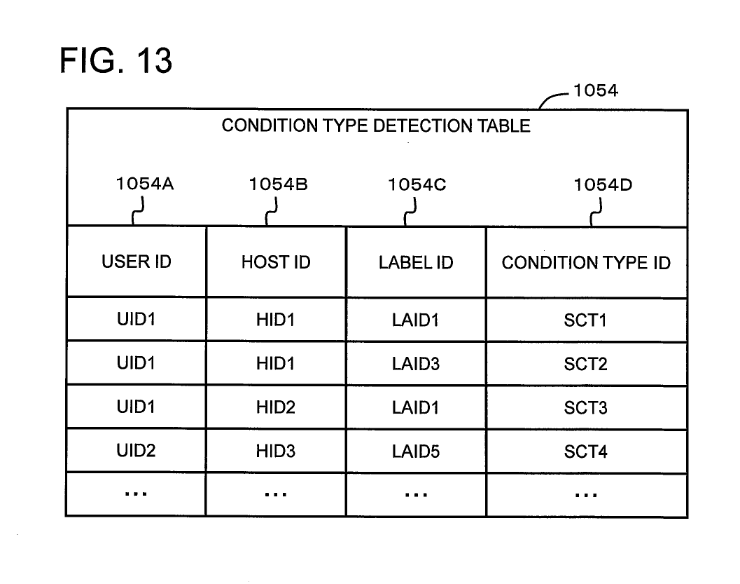

FIG. 13 shows a table 1054 for detecting a condition type. The condition type detection table 1054, for example, correspondingly manages a user ID column 1054A, a host ID column 1054B, a label ID column 1054C, and a condition type ID column 1054D.

That is, the condition type detection table 1054 is for associating a precondition with a search condition set. Using the condition type detection table 1054 makes it possible, based on the precondition (the values of the respective columns, i.e., 1054A, 1054B, 1054C), to detect the condition type ID (the value of column 1054D) that is associated with this precondition.

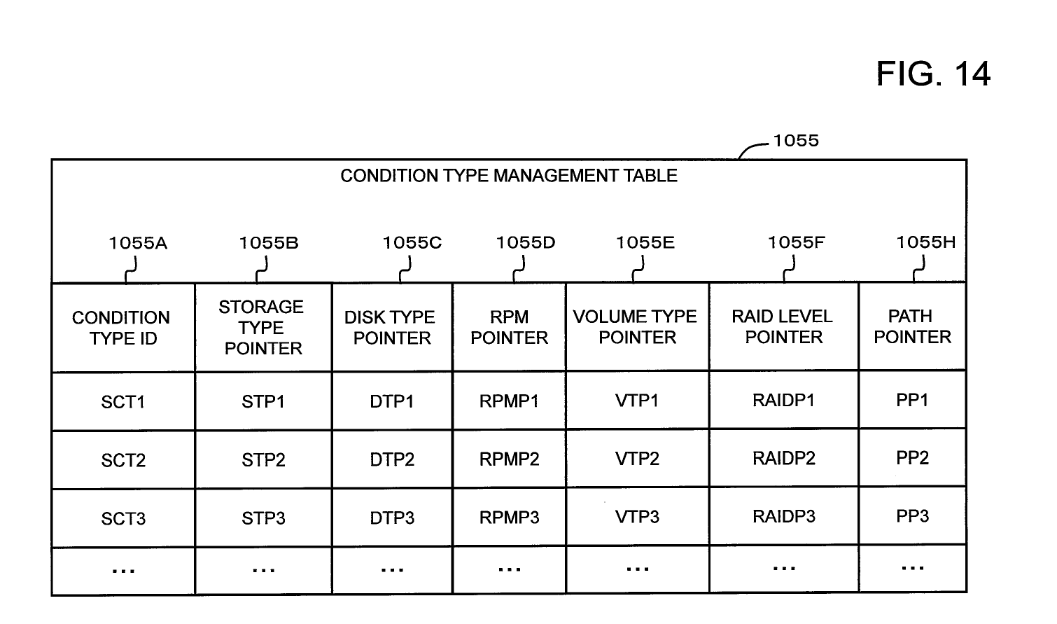

FIG. 14 shows a table 1055 for managing a condition type. The condition type management table 1055, for example, correspondingly manages a condition type ID column 1055A, a storage type pointer column 1055B, a disk type pointer column 1055C, a RPM pointer column 1055D, a volume type pointer column 1055E, a RAID level pointer column 1055F, and a communication path pointer column 1055H.

Information (an ID) for identifying a condition type is stored in the condition type ID column 1055A. A pointer for acquiring a storage type condition value and a priority as a single search condition from the priority management table 1056 is stored in the storage type pointer column 1055B. A pointer for acquiring a disk type condition value and a priority as a single search condition from the priority management table 1056 is stored in the disk type pointer column 1055C.

A pointer for acquiring a RPM condition value and a priority as a single search condition from the priority management table 1056 is stored in the RPM pointer column 1055D. A pointer for acquiring a volume type condition value and a priority as a single search condition from the priority management table 1056 is stored in the volume type pointer column 1055E. A pointer for acquiring a RAID level condition value and a priority as a single search condition from the priority management table 1056 is stored in the RAID level pointer column 1055F. A pointer for acquiring a communication path condition value and a priority as a single search condition from the priority management table 1056 is stored in the communication path pointer column 1055H.

That is, the condition type management table 1055 is for identifying a specific configuration of a search condition set for each condition type ID.

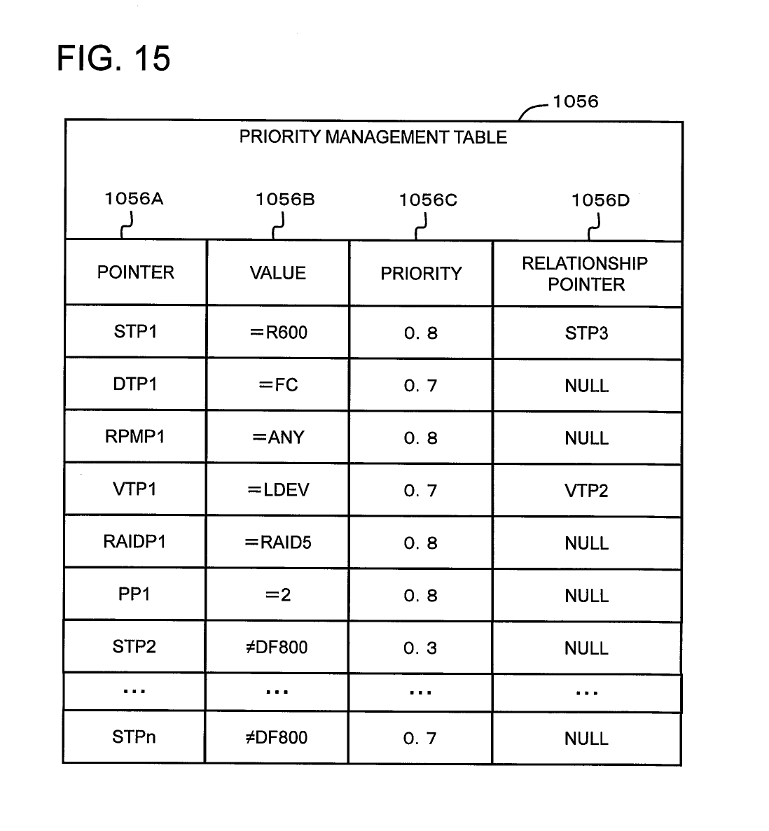

FIG. 15 shows a table 1056 for managing a priority. The priority management table 1056, for example, correspondingly manages a pointer column 1056A, a value column 1056B, a priority column 1056C, and a related pointer column 1056D.

A pointer corresponding to each search condition is stored in the pointer column 1056A. A value (a condition value), which is configured in each search condition, is stored in the value column 1056B. The priority of a condition value is stored in the priority column 1056C. Another pointer related to this search condition is stored in the related pointer column 1056 D.

This table will be explained more specifically. In the drawing, the storage type pointer is expressed as “STP”, the disk type pointer is expressed as “DTP”, the RPM pointer is expressed as “RPMP”, the volume type pointer is expressed as “VTP”, the RAID level pointer is expressed as “RAIDP”, and the communication path pointer is expressed as “PP”.

For example, it is possible to cite R700, R600, DF800 and other such model names as values that the search condition “storage type” can take. As values that the search condition “disk type” can take, for example, FC, SSD, SATA, ANY and the like can be cited. ANY signifies that any disk type regardless of its type can be used. As values that the search condition “RPM” can take, for example, 15000, 10000, 7200 and so forth can be cited. Furthermore, in a case where the search condition “RPM” is to be changed to the search condition “data transfer rate”, for example, 6 Gbps, 3 Gbps and so forth can be cited as values that the data transfer rate can take. Furthermore, as was described hereinabove, condition expressions like “=”, “≠”, “includes” and “excludes” can be configured in the condition value.

As values that the search condition “volume type” can take, for example, LDEV, RAID group, pool and the like can be cited. LDEV signifies the logical volume of the storage system 30. In a case where LDEV has been specified as the condition value, a created logical volume 34 is allocated to the host computer 20. In a case where RAID group has been specified as the condition value, the RAID group 33 is allocated to the host computer 20. The user can create a logical volume 34 using the area of the allocated RAID group 33 and allocate this logical volume 34 to the host computer 20. In a case where pool has been specified as the condition value, a virtual volume that uses Thin Provisioning technology is allocated to the host computer 20.

As values that the search condition “RAID level” can take, for example, RAID 1, RAID 5, RAID 6 and so forth can be cited. As values that the search condition “communication path” can take, 1, 2, or 3 or more can be cited. In a case where 1 has been specified as the condition value, the host computer 20 and the logical volume are coupled via a single communication path. In a case where 2 has been specified as the condition value, the host computer 20 and the logical volume are coupled via two communication paths. In a case where either one of the communication paths fails, the host computer 20 can access the logical volume using the other, normal communication path.

Next, an example of a management method (an allocation support method for a volume or the like) that utilizes the management server 10 will be explained. Each process explained below is realized by a microprocessor reading and executing the respective programs stored in the memory. Therefore, the subject of the following respective processing may be the program or the microprocessor. Or the explanation can also be given using either the controller or the server as the subject of the respective processing hereinbelow. In this example, for the sake of convenience, the operation of each program will be explained having the management server as the subject of the action.

Furthermore, the configuration may be such that either all or a part of each program is realized as a dedicated hardware circuit. Each program can be installed in the management server by way of a program delivery server for delivering a program. In addition, each program may be affixed to a recording medium and installed by being read into the management server.

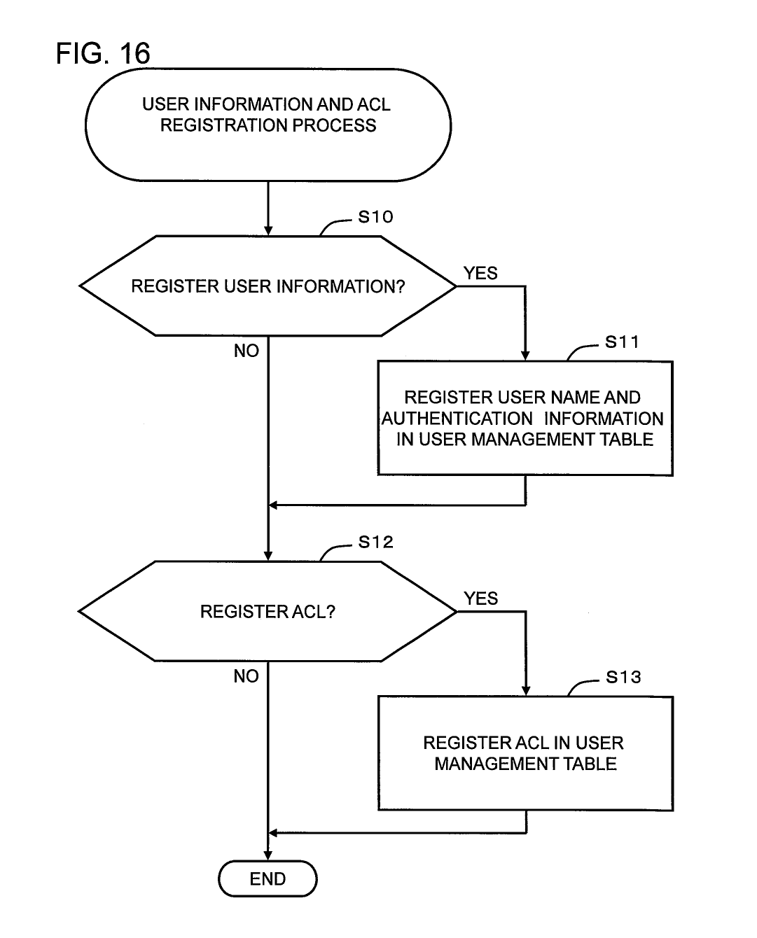

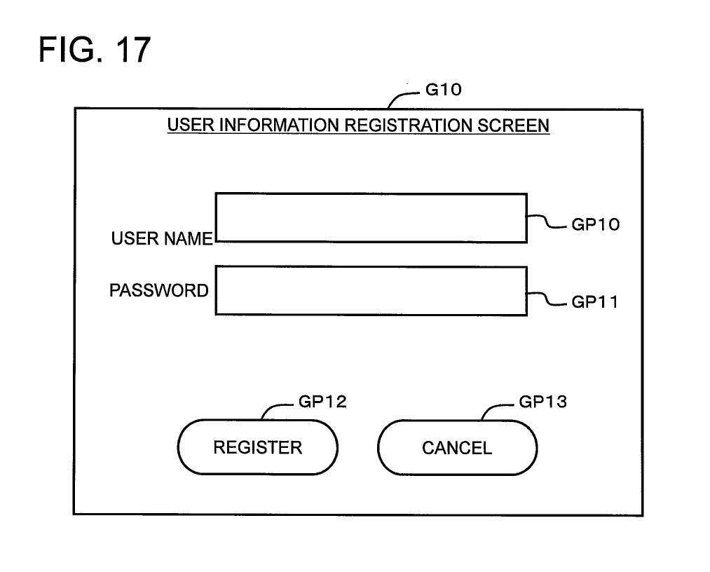

FIG. 16 shows the processing for registering user information and access control information (ACL information) in the management server 10. FIG. 17 shows an example of a screen for registering the user information. FIG. 18 shows an example of a screen for registering the ACL information.

The user accesses the management server 10 using the operation terminal 40, and opens the user information registration screen G10 shown in FIG. 17. As shown in FIG. 17, the user inputs his own name in the username input part GP10, and also inputs a password in the password input part GP11. When there are no errors in the input content, the user operates the register button GP12. In a case where the registration of the user information is to be cancelled, the user operates the cancel button GP13.

The management server 10 determines whether or not the user information is to be registered based on the operation of the register button GP12 (S10). In a case where the user information is to be registered (S10: YES), the management server 10 registers the username and password inputted to the user information registration screen G10 to the user management table 1051 shown in FIG. 10 (S11).

When the user information registration is complete, the processing moves to the registration of the ACL information. In a case where the username and password are already registered, it is possible to skip the steps related to the user information registration and move to the ACL information registration.

FIG. 18 is a screen G20 for registering the ACL information. The ACL information registration screen G20, for example, comprises a user specification part GP20 for specifying a user, a volume selection part GP21 for selecting a logical volume, a host selection part GP22 for selecting a host computer, a register button GP23 and a cancel button GP24.

The volume selection part GP21 comprises a volume display part GP25 for displaying a list of logical volumes, and a button GP26 for adding a logical volume 34 selected in the volume display part GP25 to the ACL information.

The host selection part GP22 comprises a host display part GP27 for displaying a list of host computers, and a button GP28 for adding a host computer 20 selected using the host display part GP27 to the ACL information.

That is, the user uses the registration screen G20 to specify a combination of a host computer 20 and a logical volume 34, which this host computer 20 has permission to access.

Return to FIG. 16. The management server 10 determines whether or not to register the ACL information based on the operation of the register button GP23 of the registration screen G20 (S12). In a case where the ACL information is to be registered (S23: YES), the management server 10 stores the contents inputted to the registration screen G20 in the ACL column 1051D of the user information management table 1051. When either the ACL information registration is complete or the ACL information is not registered (S23: NO), the management server 10 ends this processing.

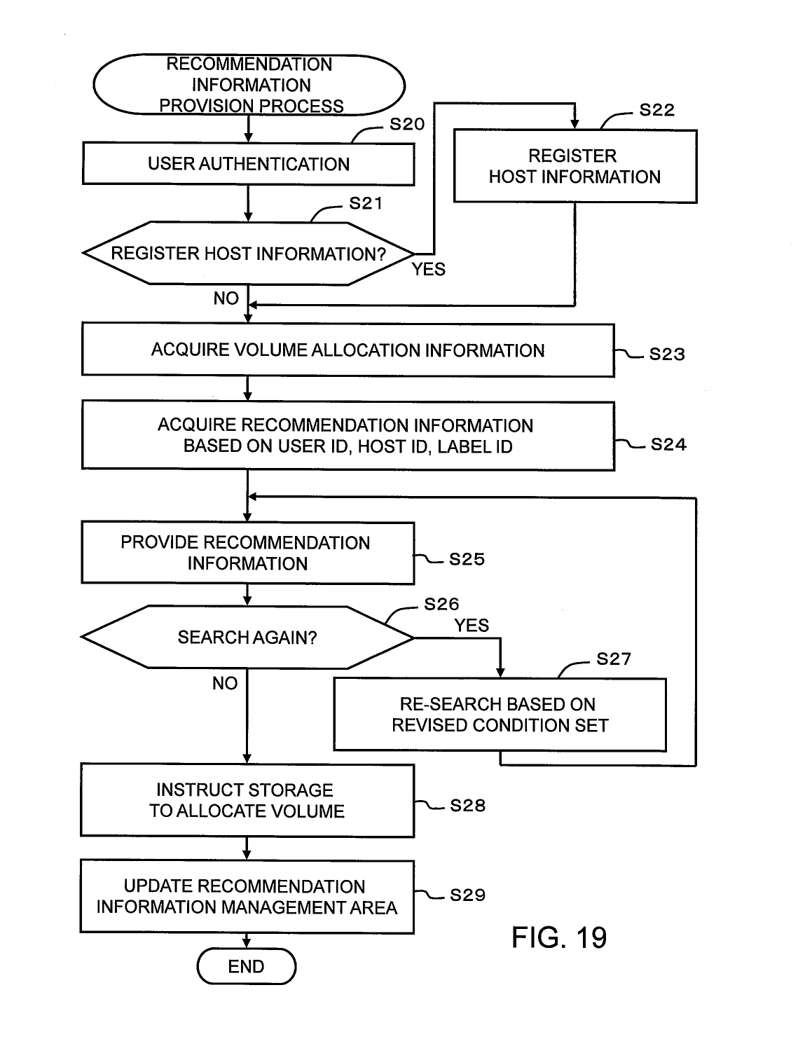

FIG. 19 shows the processing for providing recommendation information to the user. In this processing, as described hereinbelow, in a case where the user wants to allocate a volume or the like to the host computer 20, either one or multiple search condition sets are acquired based on a relatively small precondition inputted by the user. In this processing, volumes or the like are selected in accordance with these search condition sets, and these selected volumes or the like are presented to the user for final selection. In addition, in this processing, the priority of each search condition is updated based on the content of the final selection by the user, and this updated priority is provided at the next opportunity.

The user desiring the allocation of an appropriate volume or the like accesses the management server 10 using the operation terminal 40 and inputs a username and a password. The management server 10 carries out user authentication based on the username and the password inputted by the user (S20). In a case where the user authentication fails, the management server 10 sends an error message to the operation terminal 40.

When the user authentication is successful, the management server 10 determines whether or not the host information is to be registered (S21). For example, in a case where a new host computer 20 has been added to the computer system, the user registers the information regarding this new host computer in the management server 10.

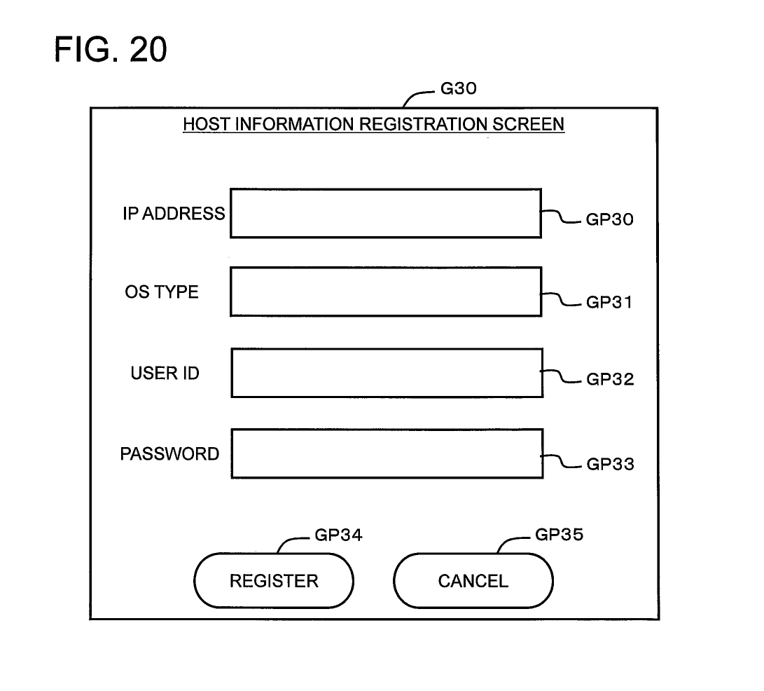

FIG. 20 shows a screen G30 for registering host information. The host information registration screen G30, for example, can comprise an IP address input part GP30, an operating system type input part GP31, a user ID input part GP32, a password input part GP33, a register button GP34, and a cancel button GP35. A place for inputting a hostname may also be provided.

The IP address, which is configured in the registration-target host computer 20, is input into the IP address input part GP30. The type of the operating system mounted in the registration-target host computer 20 is input into the operating system time input part GP31. The ID of the user managing the registration-target host computer 20 is input into the user ID input part GP32. The password for this user to login to the management server 10 is input into the password input part GP33.

When the user inputs the required information into the screen G30 and presses the register button GP34, a request is issued to the management server 10 to register the host information.

The management server 10, upon being requested to register the host information (S21: YES), registers the information (the IP address, operating system type and so forth) input by the user via the screen G30 to the host management table 1053 shown in FIG. 12 (S22).

The management server 10 acquires from the user the information for allocating a volume or the like to the host computer 20 (S23).

The information for allocating the volume or the like does not need to be inputted by the user in real-time. The configuration may be such that the information for allocating a volume or the like is stored beforehand in a prescribed storage area, and in a case where the user instructs the management server 10 to execute a volume allocation, the microprocessor of the management server 10 reads and processes this information.

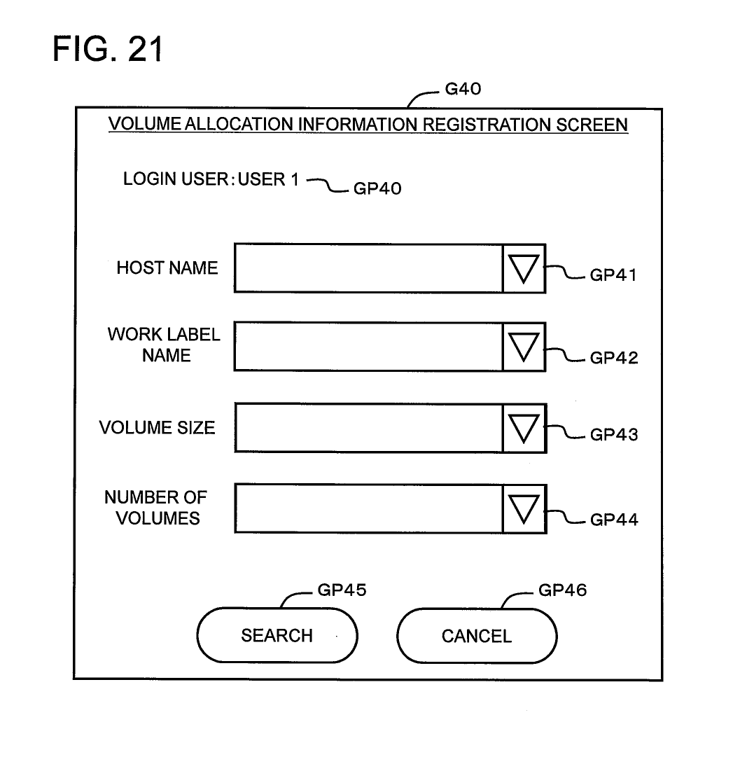

FIG. 21 shows a screen G40 for inputting information for allocating a volume or the like. The screen G40 comprises a login username display part GP40, a hostname input part GP41, a work label name input part GP42, a volume size input part GP43, a number of volumes input part GP44, a search button GP45, and a cancel button GP46.

The username for identifying the user desiring the allocation of a volume or the like is displayed in the login username display part GP40. The displayed username is included in the precondition. The hostname for identifying the host computer to which the volume or the like is to be allocated is input in the hostname input part GP41. The inputted hostname is included in the precondition. The work label name for identifying the type of the application program 21 scheduled to use the volume or the like is input to the work label specification part GP42. The inputted work label name is included in the precondition.

The size of the volume or the like to be allocated to the host computer is input to the volume size input part GP43. Normally, since the size of the volume to be input is equal to or less than the maximum size of the logical volume 34, the volume size does not need to be included in the precondition. However, the configuration may be such that the volume size is included in the precondition.

The number of volumes or the like to be allocated to the host computer is input to the number of volumes input part GP44. The number of volumes does not need to be included in the precondition for the search. The number of volumes is used for showing a fixed number of search results. For example, in a case where 10 volumes are required, the top ten volumes from among the 10 or more volumes that were retrieved are presented to the user.

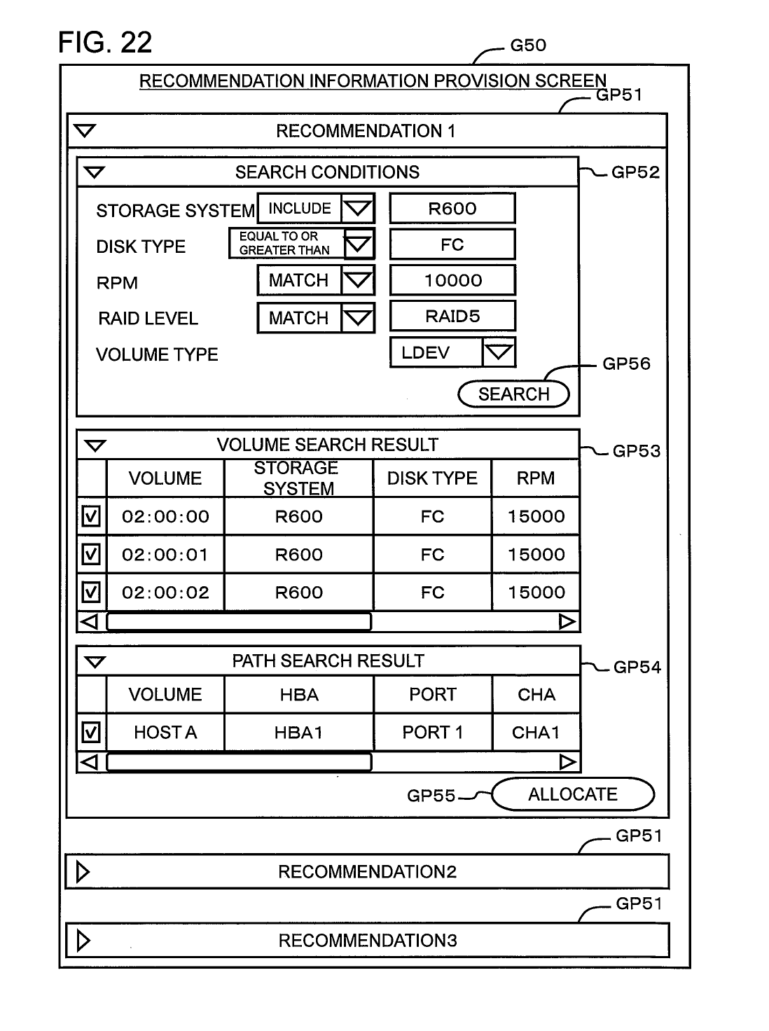

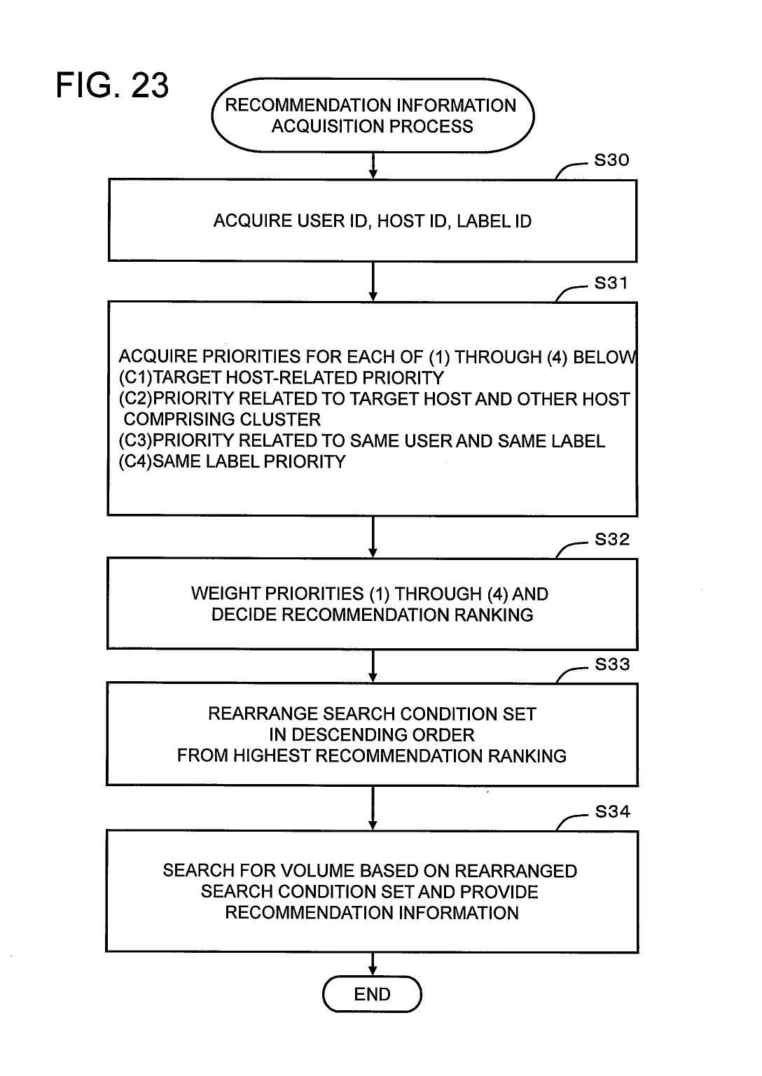

The management server 10 acquires the recommendation information for recommending a volume or the like to the user based on the precondition (the username, hostname, and work label name) inputted by the user (S24), and displays this recommendation information by sending same to the operation terminal 40 (S25). The step S24 for acquiring the recommendation information will be explained in detail further below using FIG. 23. Next, an example of providing the recommendation information will be explained by referring to FIG. 22.

FIG. 22 is a screen G50 for providing recommendation information to the user. The management server 10 can select multiple search condition sets based on a single precondition inputted by the user, and can provide the results of searches based on each search condition set to the user. Therefore, the screen G50 may comprise multiple recommendation information corresponding to the respective search condition sets.

Multiple (three in FIG. 22) recommendation parts GP51 for displaying the recommendation information are displayed in the screen G50. Each recommendation part GP51, for example, comprises a search condition display part GP52 for displaying the search condition set used in the search, a volume search result display part GP53 for displaying the volume or the like that was retrieved, a path search result display part GP54 denoting the communication path search result, and a button GP55 for instructing an allocation.

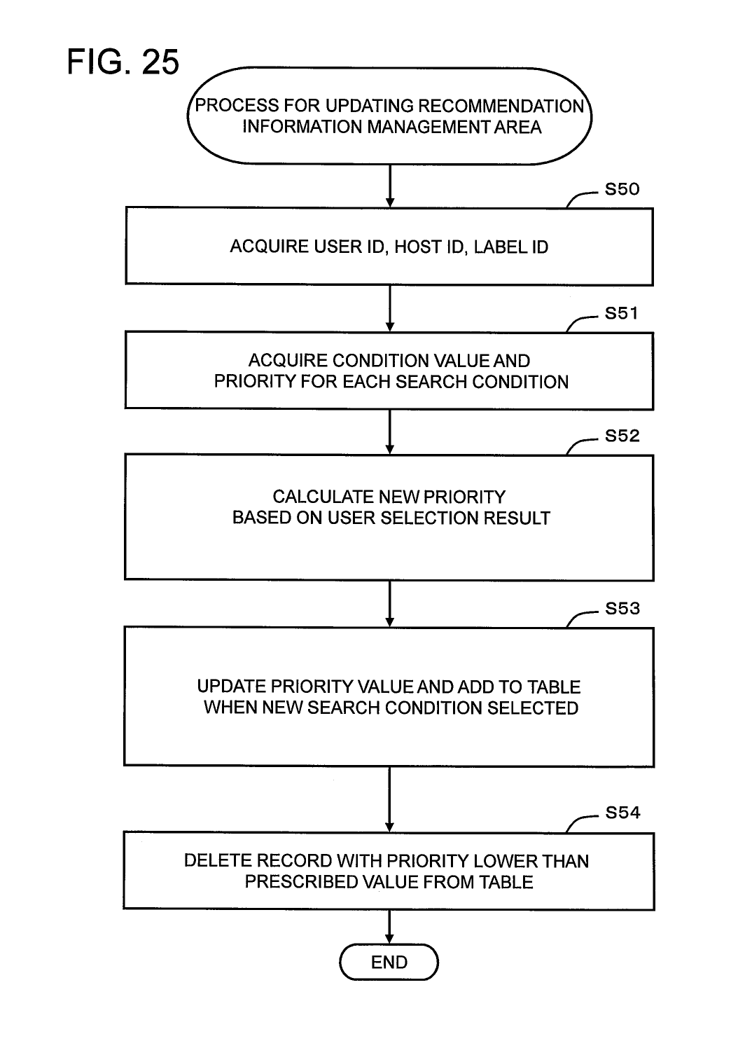

The search condition display part GP52 displays a search condition set. The search condition set can comprise multiple search conditions. Each search condition comprises a condition type and a condition value. In the example of FIG. 25, the search condition, for example, also comprises condition expressions like “includes”, “excludes”, “matches”, “equal to or larger than”, and “equal to or less than”. The condition expression, for example, can be changed by the user. The condition value (in the example of FIG. 25, R600, FC, 10000, RAID5) is also able to be changed by the user. When the user changes either all or a part of the search condition set and presses the search button GP55, the search is conducted once again based on this changed search condition set.

The user is able to select either a desired condition expression or condition value from a pull down menu. Or, the configuration may be such that the user is able to directly input the desired either condition expression or condition value. In a case where the user inputs some sort of information into the management server 10, both the above-mentioned method that uses the pull down menu and the method for directly inputting the desired either numerical value or characters can be employed.

A volume that matches the search condition set displayed in the search condition display part GP52 is displayed in the volume search result display part GP53. In a case where RAID group is configured as the volume type condition value, the RAID group ID matching the search condition set is displayed in the volume search result display part GP53. Similarly, in a case where pool is configured as the volume type condition value, the ID of the pool that matches the search condition set is displayed in the volume search result display part GP53.

Furthermore, in a case where the access control information has been configured, only a volume or the like that is accessible to the host computer to which the volume or the like is to be allocated is displayed in the volume search result display part GP53.

In a case where the number of volumes that have been searched exceeds the number of volumes specified by the user, volumes equal to or greater than the number of volumes specified by the user are displayed in the display part GP53. The configuration may be such that all of the retrieved volumes are displayed. Or, the configuration may be such that only the number of volumes specified by the user is selected from among all of the retrieved volumes using a prescribed criterion and displayed.

Return to FIG. 19. The management server 10, after providing the recommendation information to the user (S25), determines whether or not to conduct the search again based on the operation of the search button GP56 (S26). The user can change at least one part of the search condition set that was used to create the recommendation information, and instruct that the search be done once again.

In a case where a re-search has been requested (S26: YES), the management server 10 conducts the search once again based on the revised search condition set (S27). The management server 10 recreates the recommendation information based on the result of the re-search, and provides this recommendation information to the user (S25).

In a case where the user is satisfied with the contents of the recommendation information, the user presses the allocate button GP55. When the allocate button GP55 is pressed, the management server 10 instructs the storage system 30 to allocate the volume (S28) without conducting the search again (S26: NO). This instruction comprises at least information for identifying the host computer, and information for identifying the volume or the like to be allocated to this host computer. The storage system 30, upon receiving the instruction from the management server 10, changes the configuration of the storage system so that the specified host computer is able to use the specified volume or the like. The management server 10 is notified about the storage system configuration change.

The management server 10, upon confirming that the allocation of the volume or the like was completed, updates the storage contents of the recommendation information management area 1050 (S29). The method for updating the recommendation information management area 1050 will be explained further below using FIG. 25.

FIG. 23 is a flowchart showing the processing for acquiring the recommendation information. The flowchart of FIG. 23 shows details about S24 in FIG. 19.

The management server 10, based on information (a username, a hostname, and a work label name) inputted from the user, acquires a user ID, a host ID, and a work label ID (S30). The management server 10 respectively calculates the priorities (C1) through (C4) in the four cases described hereinbelow (S31).

(C1) Priority related to the host computer that is the target

(C2) Priority for another host computer comprising a cluster with the target host computer

(C3) Priority in a case where only the user-specified users and work labels match

(C4) Priority in a case where only the user-specified work labels match

In the case of C1, the management server 10 uses the user-specified precondition (username, hostname, and work label name) as-is, acquires the search condition set, and acquires the priority from the search result in accordance with this search condition set.

In the case of C2, the precondition comprises the user-specified username and work label name, and the name of the other host that comprises a cluster with the user-specified host. That is, the hostname in the user-specified precondition changes to the name of the other host computer that comprises a cluster with the specified host computer. The search condition set based on the changed-hostname precondition is acquired, and a priority is acquired from the search result according to this search condition set.

In the case of C3, preconditions, in which the work label names and the usernames specified by the user match and the hostnames are not considered, are used. That is, multiple preconditions, in which only the usernames and work label names match the user-specified contents, and the hostnames are different, are created. A number of preconditions, which are proportional to the number of host computers installed with application programs matching the work labels from among the host computers managed by the user, are created. A search condition set is acquired for each of these preconditions, and priorities are calculated from the search results according to each of these search condition sets.

In the case of C4, multiple preconditions, in which only the work label names specified by the user match and the usernames and hostnames are not considered, are used. That is, respective search condition sets are acquired based on multiple preconditions, in which only the work label names match and the usernames and hostnames are different, and respective priorities are calculated from these search results.

In this way, in a case where a certain user wishes to allocate a volume or the like in this example, there may be cases (C1) in which a priority is determined by using the precondition specified by this user as-is, and cases (C2, C3, C4) in which the management server 10 changes the user-specified precondition to broaden the range for calculating the priority. In addition, in the case of the latter, the range for calculating the priority is configured so as to expand hierarchically (C2<C3<C4). Furthermore, priorities are not necessarily calculated in all of the cases, i.e., C2, C3 and C4. For example, in the case of a host computer that does not comprise a cluster, the C2 priority is not calculated.

Since priorities are calculated in multiple cases, even when a user has little experience and sufficient operation history is not stored in a recommendation information management area 1050, either a search condition set that was created for another host or a search condition set that was created for another user can be used. In a normal case, this makes it possible to create at least one piece of recommendation information that corresponds to the precondition specified by the user.

The management server 10 weights the four types of priorities calculated in S31, and decides on the rank order for making recommendations to the user based on the post-weighted values (S32).

It is supposed here that the priority in the case of C1 is a first case priority PC1, the priority in the case of C2 is a second case priority PC2, the priority in the case of C3 is a third case priority PC3, and the priority in the case of C4 is a fourth case priority PC4. It is supposed that a PC1-multiplied weighting factor is α1, a PC2-multiplied weighting factor is α2, a PC3-multiplied weighting factor is α3, and a PC4-multiplied weighting factor is α4. α1>α2>α3>α4>0. The value of al may be configured as 1.

In S32, PC1*α1, PC2*α2, PC3*α3, and PC4*α4 are respectively calculated, and arranged in descending order from the largest priority. Multiples of each of PC2, PC3 and PC4 can exist. Each priority that has been acquired in the cases of C2, C3 and C4 is multiplied by the weighting factor.

The management server 10 rearranges the search condition sets in descending order from the highest recommendation ranking decided in S32 for each search condition (S33). The management server 10 searches for a volume or the like based on the rearranged search condition sets and provides the recommendation information (S34).

As shown in FIG. 22, multiple recommendation parts GP51 named “recommendation 1” through “recommendation 3” are provided to the user. In the example shown in FIG. 22, a recommendation part GP51 with a higher recommendation ranking is positioned in the upper part of the screen. The present invention is not limited to this, and the configuration may be such that a recommendation part GP51 with a higher recommendation ranking is positioned either on the right or left of the screen, or at the bottom. In addition, the configuration may also be such that, in a case where each recommendation part GP51 is displayed in an individual window, the recommendation part GP51 with a higher recommendation ranking will be located at the top when the respective windows are stacked.

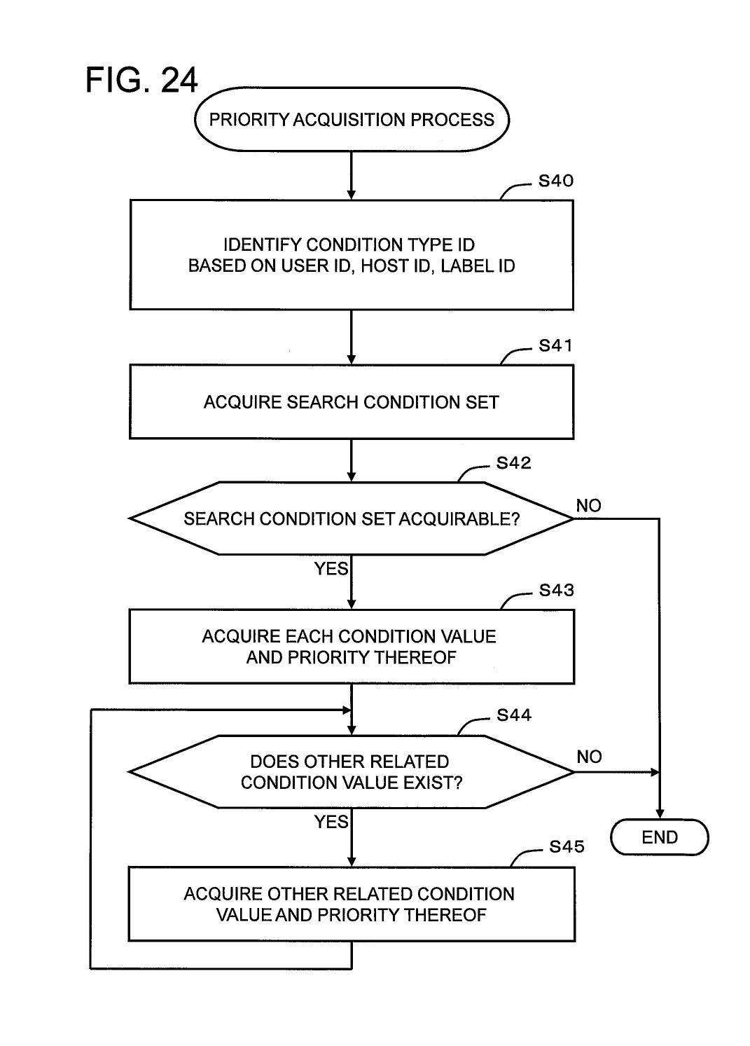

FIG. 24 is a flowchart showing the processing for acquiring (calculating) a priority. This processing shows S31 in FIG. 23 in detail.

The priorities PC1 through PC4 in the respective cases C1 through C4 described hereinabove can be determined in accordance with the processing shown in FIG. 24. The explanation will focus here on the method for determining the priority PC1 in the case (C1) where the user-inputted precondition is used as-is.

In a case where the C2 priority PC2 is to be determined, the host ID may be changed from the original target host computer ID to the ID of the other host computer comprising a cluster with the target host computer, and the processing of FIG. 24 may be executed.

In a case where the C3 priority PC3 is to be determined, the IDs of the host computers that are managed by the same user and the host computers that are installed with the application program with the same work labels as the specified work labels are used. In a case where multiple host computers exist like this, the processing of FIG. 24 is executed for each of the host computers, and one maximum priority is selected from among the respective priorities obtained in accordance therewith.

In a case where the C4 priority PC4 is to be determined, the ID of the host computer that is installed with the application program with the same work label ID as the specified work label ID is used from among all the host computers comprising the computer system. The same as in the case of PC3, in a case where multiple host computers exist a priority is determined for each host computer and one maximum priority is selected from thereamong.

The PC1 calculation method will be described. The management server 10 searches the condition type detection table 1054 shown in FIG. 14 based on the user ID, the host ID and the work label ID, and acquires a condition type ID (S40). The management server 10 searches the condition type management table 1055 based on the condition type ID and acquires one search condition set (S41).

The management server 10 determines whether or not it was possible to acquire a search condition set corresponding to the precondition in S41 (S42). In a case where it was not possible to acquire a search condition set (S42: NO), this processing ends.

In a case where it was possible to acquire a search condition set (S42: YES), the management server 10 acquires each condition value and the priority thereof from the priority management table 1056 shown in FIG. 15 (S43). In addition, the management server 10 determines whether another condition value is associated with this condition value (S44). That is, the management server 10 determines whether or not multiple condition values with different priorities are associated in a certain search condition set.

In a case where an associated other condition value exists (S44: YES), the management server 10 acquires this associated other condition value and the priority (S45). The management server 10, upon acquiring all the condition values and priorities associated thereto for a certain search condition (S44: NO), ends this processing.

For example, in a case where the condition value initially associated with the search condition “disk type” is “=FC” and this priority is 0.8, the management server 10 acquires this information (condition value “=FC”, priority 0.8).

In a case where another condition value “=SSD” is also associated with the initial condition value “=FC” and the priority thereof is 0.7, the management server 10 acquires this associated information (condition value “=SSD”, priority 0.7). The management server 10 acquires all the combinations of condition values and priorities associated with this search condition for each search condition comprising the search condition set.

FIG. 25 is a flowchart showing the processing for updating the recommendation information. This processing shows S29 in FIG. 19 in detail.

The management server 10 acquires a user ID, a host ID, and a work label ID (S50), and identifies a search condition set corresponding to this precondition (the user ID, host ID, and work label ID). The management server 10 acquires the condition value and priority for each search condition comprising the search condition set (S51).

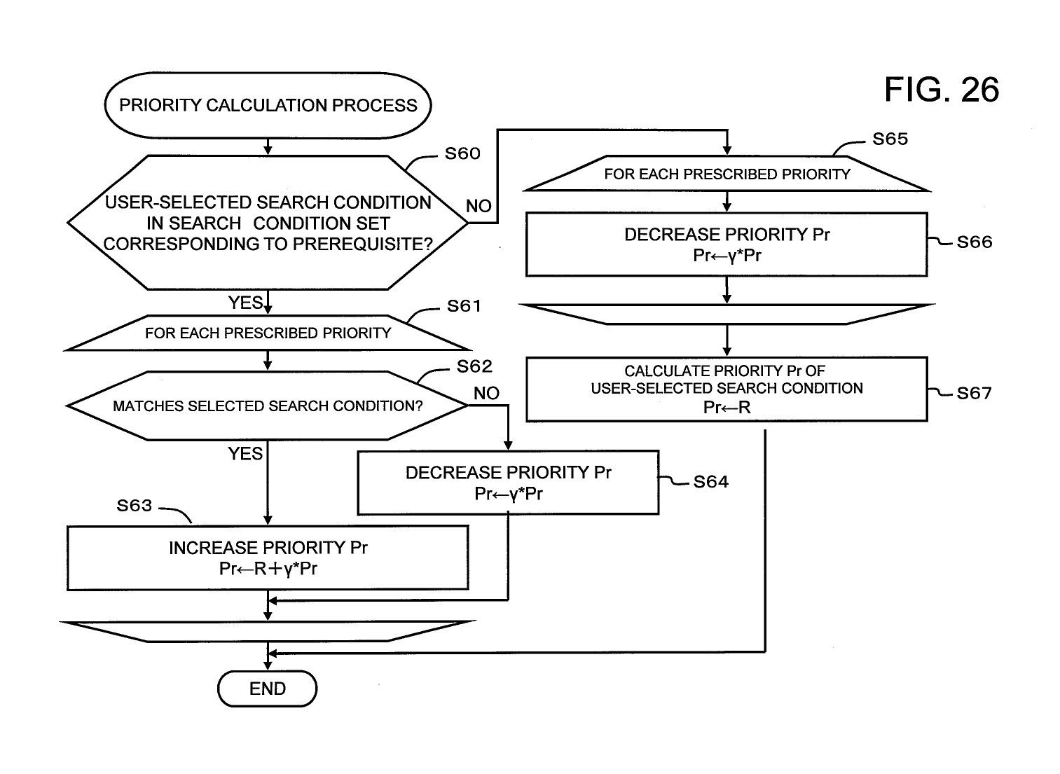

The management server 10 calculates a new priority based on the priority of each search condition selected by the user (S52). That is, the management server 10 once again calculates each priority comprising this search condition set in accordance with each priority of the search condition set ultimately selected by the user. Details will be explained further below using FIG. 26, but the priorities comprising the search condition set are calculated such that the priority becomes higher the more recently the condition value was used, and the priority of an unused condition value steadily decreases.

The management server 10 rewrites the priority for which a new value was calculated from among the priorities stored in the priority management table 1056 to this new value (S53). In addition, the management server 10, in a case where the user has selected a new search condition that has not been used up until now, adds this search condition to the priority management table 1056 (S53).

Lastly, the management server 10 deletes from among the priorities registered in the priority management table 1056 the record of a priority that falls below a prescribed value (S54). This makes it possible to remove an infrequently used search condition from the priority management table 1056. As a result of this, increases in the size of the priority management table 1056 can be held in check, enabling efficient use of the management server 10 memory resource.

FIG. 26 is a flowchart showing the processing for calculating a priority. This processing shows S52 in FIG. 25 in detail.

The management server 10 determines whether or not a user-selected search condition exists in the search condition set identified in S50 of FIG. 25 (S60). That is, the management server 10 determines whether or not the user-selected search condition exists in the search condition set corresponding to the precondition inputted by the user. In a case where the user-selected search condition exists in the search condition set corresponding to the precondition (S60: YES), the management server 10 executes each of steps S62, S63 and S64 with respect to the prescribed priorities (S61). That is, the configuration is such that rather than update all of the priorities stored in the priority management table 1056, the management server 10 only updates the search condition sets that can be traced from the condition type corresponding to the precondition.

Of all of the priorities stored in the priority management table 1056, the prescribed priorities are the priority of the search condition set that matches the precondition and the priority of the search condition set that can be traced based on the condition type associated with the precondition.

The management server 10 fetches from the priority management table 1056 one target record of the records related to the prescribed priority, and determines whether or not the contents of the target record match the search condition selected by the user (S62).

In a case where the contents of the target record match the user-selected search condition, the management server 10 carries out updating so as to increase the value of the priority Pr inside the target record (S63). For example, the management server 10 adds a Pr value by calculating the priority Pr of the search condition that has been used by the user as Pr←R+γ*Pr. Here, for example, R is configured to 1 (R=1), and the reduction rate γ is configured within a range of equal to or larger than 0 but equal to or less than 1 (0≦γ≦1). Therefore, the priority of a search condition that has been used by the user increases every time it is used, and is presented to the user as a high-ranking recommendation.

Alternatively, in a case where the contents of the target record do not match the user-selected search condition (S62: NO), the management server 10 carries out updating so as to decrease the value of the priority Pr in the target record (S64).

For example, the management server 10 decreases the Pr value by calculated the priority Pr of the search condition that has not been selected by the user as Pr←γ*Pr. Therefore, the priority of a search condition that has not been used by the user steadily decreases, and is presented to the user as a low-ranking recommendation. When the priority Pr finally falls below a prescribed value, this record is deleted from the priority management table 1056.

In a case where a search condition that has been selected by the user is not registered in the priority management table 1056 (S60), the management server 10 executes Step S66 with respect to the prescribed priorities (S65).

The management server 10 decreases the priority Pr in the target record in accordance with the same operational expression as that of S64 (S66).

Lastly, the management server 10 calculates the priority Pr with respect to a new search condition selected by the user as Pr←R (S67). R, for example, is configured as 1.

In this way, in a case where the user uses anew search condition, the priorities of the existing search condition corresponding to the new search condition are configured lower (S66), and the priority of the new search condition is calculated so as to become the highest (S67).

As described hereinabove, in this example, a search condition set corresponding to a precondition is presented to the user by the user simply inputting the precondition for conducting a search into the management server 10. The user may use the presented search condition set as-is, or may change at least one part of the presented search conditions before use.

In this example, since a search condition set is provided by using a user-inputted precondition and an operation history like this, the amount of information inputted by the user can be reduced, and the efficiency of allocating a volume or the like to the host computer can be increased. In this example, there is no need to manage policies that increase on a day by day basis as in the prior art, making it possible to lessen the management burden placed on the user. The precondition, for example, can be expressed as a condition necessary for acquiring at least one search condition set by using the operational history of the user.

In addition, in this example, the priority of a search condition will change in accordance with frequency of use by the user, and the recommendation ranking provided to the user is decided based on the priority. This makes it possible to provide the user with search conditions in descending order beginning with the search condition that the users uses most often, and enables the user to quickly find frequently used search conditions.

In this example, the priority of a search condition that the user does not use is configured low and is deleted from the priority management table 1056 when it falls below a prescribed value. Therefore, the memory resource of the management server 10 can be used efficiently.

In this example, rather than simply recording the user operational history chronologically, the same type of record is only saved one time. The priority of an existing record changes in accordance with user usage. Therefore, increases in the size of the priority management table 1056 can be held in check, enabling the memory resource to be used efficiently.

In this example, the priorities of multiple cases C1 through C4 are respectively calculated and weighted, and a user recommendation ranking is decided in accordance with the size of this priority. Therefore, even a user with scant experience managing the computer system will be able to select an appropriate volume or the like by using another user's operational history. This enhances user usability.

Furthermore, the present invention is not limited to the examples described hereinabove. A person having ordinary skill in the art will be able to make various additions and changes without departing from the scope of the present invention.

### REFERENCE SIGNS LIST

10 Management server

20 Host computer

21 Application program

30 Storage system

32 Storage apparatus

33 RAID group

34 Logical volume

1. A method for managing a computer system, which comprises one or more host computers, one or more storage systems for storing data to be used by the host computers, and a management apparatus,
wherein the management apparatus:
(A) receives at least a required storage size and host identification information for identifying the host computer as a precondition for searching for one or more storage areas to be allocated to the host computer from among multiple storage areas of the storage system;
(B) receives further one or more search conditions for searching for one or more storage areas to be allocated to the host computer from among the multiple storage areas;
(C) detects, based on the precondition and the search conditions, one or more storage areas from among the multiple storage areas of the storage system as candidates;
(D) presents the detected candidates to a user;
(E) receives storage area identification information for identifying a storage area selected by the user from among the presented candidates;
(F) instructs the storage system to allocate, to the host computer, the storage area identified by the storage area identification information, by specifying the storage area identification information and notifying the storage system;
(G) updates, based on the search conditions, priority management information for managing priorities related to the search conditions;
(H) upon receiving the precondition once again, creates, based on the priorities managed in the priority management information, one or more search condition sets comprising one or more search conditions as recommended search condition sets to be recommended to the user;
(I) detects, based on the search conditions included in the recommended search condition set, one or more storage areas from among the respective storage areas of the storage system as candidates; and
(J) associates the detected candidates and the search conditions included in the recommended search condition set and presents same for each of the recommended search condition sets.

2. A computer system management method according to claim 1, wherein the management apparatus:
(K) priorities managed by the priority management information are updated based on the recommended search condition set selected by the user from among the recommended search condition sets that have been presented.

3. A computer system management method according to claim 1, wherein the host computer comprises a first host computer and a second host computer, which are identified by mutually different host identification information, and
a prescribed priority of the priorities managed by the priority management information comprises a value related to the first host computer and a value related to the second host computer.

4. A computer system management method according to claim 1, wherein the management apparatus uses business program identification information for identifying a business program executed on the host computer to manage a first business program and a second business program to be executed on the host computer, and
a prescribed priority of the priorities managed by the priority management information comprises a value related to the first business program and a value related to the second business program.

5. A computer system management method according to claim 1, wherein the management apparatus uses user identification information for identifying each user to manage a first user and a second user, and
a prescribed priority of the priorities managed by the priority management information comprises a value related to the first user and a value related to the second user.

6. A computer system management method according to claim 1, wherein a record with a priority of less than a prescribed value from among the priorities managed by the priority management information is deleted.

7. A computer system management method according to claim 1, wherein, in a case where the precondition received in the (H) comprises at least either one of user identification information for identifying each user or business program identification information for identifying a business program to be executed on the host computer,
the management apparatus:
respectively acquires, from among the priorities managed by the priority management information, a priority in which the host identification information and either one of the user identification information or the business program identification information match, and a priority in which either one of the user identification information or the business program identification information matches, and
presents the user with one or more search condition sets, which comprise one or more search conditions corresponding to a priority with the highest value of the respective acquired priorities, as the recommended search condition set with the highest recommendation ranking.

8. A computer system management method according to claim 1, wherein, in a case where the precondition received in the (H) comprises user identification information for identifying each user and business program identification information for identifying a business program to be executed on the host computer,
the management apparatus:
respectively acquires, from among the priorities managed by the priority management information, a priority in which the host identification information, the user identification information and the business program identification information match, another priority in which the user identification information and the business program identification information match, and yet another priority in which only the business program identification information matches, and
presents the user with one or more search condition sets, which comprise one or more search conditions corresponding to a priority with the highest value of the respective acquired priorities, as the recommended search condition set with the highest recommendation ranking.

9. A computer system management method according to claim 1, wherein a priority for each search condition is managed in the priority management information, and
in the (G), it is determined whether or not a priority related to a search condition corresponding to the storage area selected by the user is registered in the priority management information, and in a case where this priority is not registered, the priority of this search condition is calculated and this priority is registered in the priority management information.

10. A computer system management method according to claim 1, wherein, in the (J), the search condition included in the recommended search condition set is able to be revised by the user.

11. A computer system management method according to claim 1, wherein the storage area is at least either one of a logical volume or a RAID (Redundant Array of Independent Disks) group.

12. A management apparatus, which is coupled to one or more host computers and one or more storage systems for storing data to be used by the host computers, the management apparatus comprising:
a communication interface for communicating with the host computers and the storage systems;
a memory for storing a prescribed computer program; and
a microprocessor for reading and executing the prescribed computer program stored in the memory, wherein the microprocessor:
(A) receives at least a required storage size and host identification information for identifying the host computer as a precondition for searching for one or more storage areas to be allocated to the host computer from among multiple storage areas of the storage system;
(B) receives further one or more search conditions for searching for one or more storage areas to be allocated to the host computer from among the multiple storage areas;
(C) detects, based on the precondition and the search conditions, one or more storage areas from among the multiple storage areas of the storage system as candidates;
(D) presents the detected candidates to a user;
(E) receives storage area identification information for identifying a storage area selected by the user from among the presented candidates;
(F) instructs the storage system to allocate, to the host computer, the storage area identified by the storage area identification information, by specifying the storage area identification information and notifying the storage system;
(G) updates, based on the search conditions, priority management information for managing priorities related to the search conditions;
(H) upon receiving the precondition once again, creates, based on the priorities managed in the priority management information, one or more search condition sets comprising one or more search conditions as recommended search condition sets to be recommended to the user;
(I) detects, based on the search conditions included in the recommended search condition set, one or more storage areas from among the respective storage areas of the storage system as candidates; and
(J) associates the detected candidates and the search conditions included in the recommended search condition set and presents same for each of the recommended search condition sets.

13. A management apparatus according to claim 12, wherein the microprocessor:
(K) priorities managed by the priority management information are updated based on the recommended search condition set selected by the user from among the recommended search condition sets that have been presented.

14. A management apparatus according to claim 13, wherein the host computer comprises a first host computer and a second host computer, which are identified by mutually different host identification information, and
a prescribed priority of the priorities managed by the priority management information comprises a value related to the first host computer and a value related to the second host computer.
